(19) United States
(12) Patent Application Publication
(10) Pub. No.: US 2010/0300475 A1
(43) Pub. Date: Dec. 2, 2010

(54) APPLICATOR FOR COSMETICS

(76) Inventor: Jean-Louis Gueret, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/739,363

(22) PCT Filed: Oct. 23, 2008
(86) PCT No.: PCT/IB2008/054383

§ 371 Date: Aug. 11, 2010

Related U.S. Application Data
(60) Provisional application No. 60/985,116, filed on Nov. 2, 2007.
(60) Provisional application No. 61/102,632, filed on Oct. 3, 2008.

(30) Foreign Application Priority Data
Oct. 23, 2007 (FR) 0758527

(51) Int. Cl. A45D 40/26; A46B 11/00; B29C 45/14

(52) U.S. Cl. 132/218; 401/129; 264/255

(57) ABSTRACT

The present invention relates to an applicator for combing the eyelashes and/or the eyebrows, and/or for applying a cosmetic, makeup, or a care product thereto, the applicator comprising a molded applicator member (8) comprising a core (10) that is elongate along a longitudinal axis, and rows of teeth, of which at least one first row of teeth is molded out of a first material, and at least one second rows of teeth is molded out of a second material that is different from the first material, wherein the two materials have the same chemical nature and differ in their hardnesses.

The present invention relates to an applicator for combing keratinous fibers, in particular the eyelashes and/or the eyebrows, and/or for applying a cosmetic, makeup, or a care product, e.g. mascara, thereto.

Numerous applicator members are known that are made by molding a thermoplastic material. Many such applicators are made with teeth that are identical.

Publication DE 101 02 219 A1 discloses an applicator member comprising a support portion made out of a first material, and a sheath carrying teeth and surrounding the support portion. The sheath and the teeth are molded out of a second material that is different from the first, being more flexible.

EP 1 161 896 A1 also describes using two materials of different stiffnesses for making an applicator member.

WO 01/05 274 A1 discloses a comb made of two portions that are interconnected via a film hinge, the portions possibly being made out of different materials. The teeth carried by each of the portions are not molded in their final configuration within the applicator member, it being necessary to move one portion relative to the other in order to assemble them, either while they are being extracted from the mold or once they have been extracted from the mold.

Application DE 199 11 763 discloses a mascara applicator including rows of transverse teeth made out of different plastics materials.

Application EP 1 602 300 discloses a mascara applicator comprising a comb having a single row and a core made out of a first material, on which core a brush made out of a second more-flexible material is over-injected or bonded.

Applications US 2003/02 13498 and US 2006/02 72666 disclose rows of teeth that can vary in density, length, shape, rigidity, or orientation.

The invention seeks to improve still further applicators for applying a composition to the eyelashes or the eyebrows.

In exemplary embodiments, the invention provides an applicator for combing the eyelashes and/or the eyebrows and/or for applying a cosmetic, makeup, or a care product thereto, the applicator comprising a molded applicator member comprising a core that is elongate along a longitudinal axis, and rows of teeth of which at least one first row of teeth is molded out of a first material, and at least one second row of teeth is molded out of a second material that is different from the first material, wherein the two materials have the same chemical nature and differ in their hardnesses.

The wording “same chemical nature” is to be understood as follows.

The two materials may belong to a same family of polymer, for example a elastomer or a thermoplastic elastomer.

Within a family they may correspond to polymers obtained from the same monomer or type of monomer, or the same monomers or same type of monomers, being in this case copolymers.

The copolymers of the same chemical nature may differ by the special distribution of the monomers, being alternating or statistical copolymers, and or by the proportions of the monomers in the copolymers.

Within a family the two materials may correspond to polymers having a same backbone with different and/or identical lateral chains and/or substituents.

Within a family they may correspond to different grades, due for example to different degree of cross linking and/or a different degree of polymerization.

The two materials may differ by their additive(s) and/or plasticizer(s), and/or may comprise a same additive and/or plasticizer in different quantity.

The two materials may also each comprise more than one polymer, for example two polymers having the same chemical nature, with different hardnesses.

The single or two polymers may be chosen in the following list, which is not limiting: polyethylene (PE), polyester, for example Hytrel®, polyamide polyester, for example Pebax®, polystyrene, for example SIS or SEBS, polyvinyl chloride (PVC), ethylene-propylene-terpolymere rubber (EPDM), polyurethane, ethyl vinyl acetate (EVA).

The single or the two polymer(s) may be elastomeric or not elastomeric, or one of each.

The two materials may each comprise the two same polymers, but in different proportions, having different hardnesses.

In exemplary embodiments, the first material may comprise an elastomeric polymer, as for example polystyrene, and a non-elastomeric polymer of the same chemical nature, as for example SEBS. The second material may comprise the same two polymers in different proportion, with a different hardness.

In exemplary embodiments, the first material may comprise an elastomeric polymer, as for example polyamide 6, and a non-elastomeric polymer of the same chemical nature, as for example polyamide polyester, as Pebax®.

In exemplary embodiments, the first material may comprise an elastomeric polymer, as for example polyethylene, and a non-elastomeric polymer of the same chemical nature, as for example elastomeric polyethylene.

The two material may be e.g. two polyester, having different hardnesses, for example Hytrel® 40 Shore A and Hytrel° 70 Shore A, for example two polyether block amide such as two different grades of PEBAX®, or two different polyolefins, for example with the same number of carbons, or two different polyamides, for example two grades of Nylon®.

Those exemplary embodiments are not limiting.

The use of two materials of the same chemical nature may facilitates the molding of the applicator, the compatibility between both materials being greater thanks to their same chemical nature.

In one of its aspects, the invention provides an applicator for combing the eyelashes and/or the eyebrows, and/or for applying a cosmetic, makeup, or a care product thereto, the applicator comprising a molded applicator member comprising a core that is elongate along a longitudinal axis, and rows of teeth, of which at least one first row of teeth is molded out of a first material, and at least two second rows of teeth are molded out of a second material that is different from the first material. The applicator of the invention enables teeth to be made having properties and/or colors that are different as a function of the material from which the teeth are made.

This makes it easy to make an applicator member having different application characteristics, by virtue of the materials used, exclusively or in addition to at least one additional difference between the teeth associated with their shape, length, thickness, disposition in the row, and/or implantation on the core, amongst other criteria.

Independently or in combination with the above, the invention also provides an applicator for combing the eyelashes and/or the eyebrows, and/or for applying a cosmetic, makeup, or a care product thereto, the applicator comprising a molded applicator member comprising a core that is elongate along a longitudinal axis, and rows of teeth, of which at least one first row of teeth is molded out of a first material, and at least one second row of teeth is molded out of a second material that is different from the first material, the two rows of teeth being molded in their final configuration within the applicator member.

Independently or in combination with the above, the invention also provides an applicator for combing the eyelashes and/or the eyebrows, and/or for applying a cosmetic, makeup, or a care product thereto, the applicator comprising a molded applicator member comprising a core that is elongate along a longitudinal axis, and rows of teeth, of which at least one first row of teeth is molded out of a first material, and at least one second row of teeth is molded out of a second material that is different from the first material, at least a first tooth of a first row and a second tooth of a second row extending in directions that are not parallel.

In exemplary embodiments, the invention also provides an applicator for combing the eyelashes and/or eyebrows, and/or for applying a cosmetic, makeup, or a care product thereto, the applicator comprising a molded applicator member comprising a core that is elongate along a longitudinal axis, and rows of teeth, of which at least one first row of teeth is molded out of a first material, and at least one second row of teeth is molded out of a second material that is different from the first material, at least a first tooth of a first row and a second tooth of a second row differing in their length, or in their trickness, or in the spacing between the teeth in one row, or in the arrangement of the teeth in one row.

The applicator may comprise at least two second rows of teeth molded out of the second material

In an embodiment of the invention, the applicator member does not have any axis of symmetry. The applicator need not be symmetrical about a mid-plane that is situated between the first and second rows.

The term “longitudinal axis” of the core should be understood as the line that joins the centers of gravity (barycenters) of the cross-sections of the core. In some circumstances, the longitudinal axis may be a central axis, or even an axis of symmetry for the core, in particular when the core presents a cross-section that has the general shape of a regular polygon or a circle. The longitudinal axis may be rectilinear or curved.

The core of the applicator may be made out of a single material. The core may be made out of the first material or out of the second material.

The core of the applicator may comprise first and second portions that extend along the longitudinal axis of the core, and from which the first and second rows extend respectively, the first portion being made out of the first material, and the second portion being made out of the second material.

The term “portion of the core” is used to mean a longitudinal portion of the core extending angularly around the longitudinal axis through about 180°, for example, or through some other angle, e.g. lying in the range 150° to 210°. Each of the first and second portions of the core may constitute substantially half of the core. In a variant, each of the first and second portions of the core may constitute substantially one third, one fourth, one fifth, one sixth, or one eighth of the core.

The term “tooth” is used to designate an element that projects individually, the term being synonymous with “bristle” in the context of the present invention.

The teeth of the first rows of teeth and the first portion of the core may be made out of the same material.

The teeth of the second rows of teeth and the second portion of the core may be made out of the same material.

The teeth of the first rows of teeth may be made out of a material that is different from the first portion of the core.

The teeth of the second rows of teeth may be made out of a material that is different from the second portion of the core.

By way of example, the two materials may have mechanical properties that are different, in particular in terms of hardness or of elasticity, one of the materials being softer than the other, for example, or they may even have colors that are different. When the materials have colors that are different, this can make it easy to identify the portion being used, if so desired by the user.

The two materials may belong to the same family of compounds. By way of example, the two materials may have the same chemical nature but different hardnesses.

The two materials may alternate around the longitudinal axis of the core at its periphery.

The two above-mentioned materials may have surface tensions relative to the composition that are different.

The first and second rows may be substantially identical. The first and second rows may be images of each other on turning about the longitudinal axis. The teeth of the first row and the teeth of a second row may be substantially identical.

The applicator may comprise a plurality of first rows of teeth molded out of the first material, the first rows of teeth being images of one another on turning about the longitudinal axis of the core. The second rows of teeth may be images of one another on turning about the longitudinal axis of the core.

At least one of the first portion and of the second portion may present a cross-section that is substantially constant along the longitudinal axis, in particular at least over a fraction of the length.

In a variant, at least one of the first portion and of the second portion may present a cross-section that varies along the longitudinal axis.

Over at least a fraction of their length, the core and/or portions of the core may present a cross-section of shape selected from the following list: circular; semi-circular; elliptical; semi-elliptical; polygonal; triangular; square; rectangular; pentagonal; hexagonal; and octagonal. The shape may vary along the longitudinal axis of the core.

The ends of the teeth of the first rows of teeth may define a first half envelope surface of the applicator, the ends of the teeth of the second rows of teeth may define a second half envelope surface of the applicator, the first and second half envelope surfaces having shapes that are different, for example.

One of the two half envelope surfaces of the applicator may have a greatest transverse dimension, e.g. a diameter, that is less than 5.5 millimeters (mm).

The other of the two half envelope surfaces may have a greatest transverse dimension, e.g. a diameter, lying in the range 5.7 mm to 10 mm, e.g. about 6.5 mm to 7 mm.

At least one row of teeth may be disposed on the core in a manner that is different from another row of teeth, the two rows differing in at least one of the following ways: the length of the teeth; the spacing of the teeth in the row; the implantation of the teeth in the row; the number of teeth in the row; the thickness of the teeth measured perpendicularly to their longitudinal direction; the material forming the teeth; the shape of the teeth; the shape of the cross-section of the teeth, the length of the teeth in the spacing of the teeth in the row.

The teeth of the first rows of teeth and the teeth of the second rows of teeth need not be disposed within their rows in the same manner relative to the core.

The teeth of the first rows of teeth may be spaced apart by a first spacing, the teeth of the second rows of teeth may be spaced apart by a second spacing, the first spacing being different from the second spacing, in particular smaller than the second spacing. The teeth of the first rows of teeth and the teeth of the second rows of teeth differ in the shape of the teeth.

The teeth of the first rows of teeth may have thickness that is less than the thickness of the teeth of the second rows of teeth. The widths of the teeth are measured at the same distance from the core, e.g. at no distance from the core, i.e. at the base of the teeth. The teeth of the first rows of teeth may be thinner, and they may be made out of a material that is harder than the material of the teeth of the second rows. Conversely, the teeth of the first rows may be thinner, and they may be made out of a material that is more flexible than the material of the teeth of the second rows.

The teeth may have thickness lying either in the range 0.2 mm to 0.5 mm, better in the range 0.2 mm to 0.45 mm, or even in the range 0.2 mm to 0.39 mm, or else in the range 0.5 mm to 0.6 mm. The term “thickness of a tooth” is used to designate the greatest cross-section of the tooth.

In the first instance, i.e. when the thickness lies in the range 0.2 mm to 0.5 mm, the teeth are relatively fine and may also be relatively flexible when the material from which they are made is a flexible material.

In the second instance, i.e. when the thickness lies in the range 0.5 mm to 0.65 mm, the teeth are thicker and may be more rigid.

The thickness of the teeth could be selected as a function of the type of makeup effect desired and/or the nature of the eyelashes to be treated and/or the rheology of the composition, for example.

The applicator may comprise only teeth having thickness lying in the range 0.2 mm to 0.5 mm, or, in a variant, only teeth having thickness that is strictly greater than 0.5 mm and less than 0.65 mm, or it may even comprise both. By way of example, teeth having a certain thickness may be mixed with teeth having another thickness, or, in a variant, teeth having a certain thickness may be grouped together in one region of the applicator member, e.g. on one portion thereof, while teeth having another thickness are grouped together in a second region of the applicator member, e.g. on a portion thereof, e.g. opposite from the first portion.

The applicator may comprise rows of short teeth, the teeth of the rows of short teeth having a maximum length, measured from the core, of 1.75 mm, for example. In addition, the applicator may comprise rows of long teeth, the teeth of the rows of long teeth having a length, measured from the core, that lies in the range 1.35 mm to 3 mm, for example. The minimum length of the long teeth is at least 0.25 mm greater than the maximum length of the short teeth.

The first rows may be rows of long teeth that are made out of a material that is more flexible than the second material. Conversely, the first rows may be rows of long teeth that are made out of a material that is harder than the second material. The second rows may be rows of small teeth.

The term “length of tooth” is used to designate the distance measured along the long direction of the tooth between the free end of the tooth and its base via which it is connected to the core. The length of a tooth is thus measured from the core of the applicator member.

The term “short teeth” is used to mean the teeth of the applicator member having a length that is strictly less than a threshold length, and the term “long teeth” is used to mean the teeth of the applicator member having a length that is strictly greater than the same threshold length. By way of example, the threshold length may be an average length of a majority, or even of all, of the teeth of the applicator member. A row of short teeth comprises a majority of short teeth, and in the limit all of the teeth of the row may be short teeth. A row of long teeth comprises a majority of long teeth, and in the limit all of the teeth of the row may be long teeth.

The teeth may have a length lying in the range 0.5 mm to 1.8 mm, or even in the range 0.5 mm to 1.49 mm, e.g. in the range 0.5 mm to 0.99 mm. More than half of the teeth of one of the portions may have a length as defined above, better at least 60%, or even 70%, better still 80% of the teeth of one of the portions. The teeth having a length as defined above may be situated in the central portion of the applicator member, for example.

The teeth of length lying in the range 0.5 mm to 1.8 mm may be distributed uniformly over the applicator member or they may be grouped together on at least one portion thereof.

The applicator may be made so that the teeth presenting a length lying in the range 0.5 mm to 1.8 mm are distributed all around the core over at least a fraction of the length thereof, thereby defining a combing surface having properties that are substantially constant all around the core over at least a fraction of the length of the applicator member.

All of the teeth of a portion of the applicator member may have the same length, except possibly the teeth situated in the vicinity of each of the two ends of the applicator member.

The applicator may comprise between 150 and 500 teeth, for example.

The teeth may be disposed in rows extending along the longitudinal axis of the core. The term “row” is used to designate a succession of teeth that are generally situated on the same side of the core, and that succeed one another along the core. The applicator may comprise at least three rows of teeth extending along the longitudinal axis, e.g. between 3 and 20 rows of teeth, better between 4 and 18 rows, better still between 6 and 10 rows.

The applicator may comprise 16 rows of teeth.

A row of teeth extending along the longitudinal axis may have at least three teeth of the same length.

Within a row of teeth, the number of teeth may lie in the range about 6 to 60, in particular in the range about 10 to 50.

At least one row of teeth may extend along a rectilinear axis that may optionally be parallel to the longitudinal axis of the core.

At least two teeth of at least one row may present lengths that are different or identical.

At least two teeth of at least one row may present shapes that are different or identical.

At least one tooth of at least one row may present a general shape that tapers towards its free end.

At least one tooth may be of tapered, frustoconical, or pyramid shape.

At least one tooth of one of the rows may present a shape that is different from a tooth of another row.

Each of two consecutive teeth of a row may extend along a direction from the core, the two directions forming a non-zero angle between them.

When the core is observed along its longitudinal axis, two teeth of a row may extend at their bases in directions that form a first angle between them, and two teeth of another row may extend at their bases in directions that form a second angle between them, the first and second angles being equal or different.

Within each row, the teeth may be spaced-apart evenly along the longitudinal axis of the row, or they may be grouped together in groups of two or more teeth, the spacing between the teeth of one group along the longitudinal axis of the row being less than the spacing between two adjacent groups of teeth of said row.

By adapting the shape of the teeth and their spacing, it is possible to establish cavities of greater or smaller size between the teeth, such cavities being suitable for being loaded with composition. It is thus possible to make a row of teeth that is capable of being loaded with a substantial quantity of composition, but without the row of teeth losing its capacity to grip the eyelashes.

Two rows of teeth may be made out of different respective materials. In addition, the teeth of a single row of teeth may be made out of different materials, e.g. of different hardness or color.

At least two successive teeth of a row may optionally be touching at their base, all of the teeth of the row respectively being non-touching or touching at their bases. The spacing between the teeth, measured between the bases of the teeth and not between the axes of the teeth, may lie in the range 0 to 1.2 mm within a row, e.g. in the range 0.01 mm and 1 mm.

When the teeth are touching at their base, the spacing between the teeth measured at the base of the teeth is zero.

When the applicator is observed in section perpendicularly to its longitudinal axis, at least two consecutive teeth of a row may define a V-shaped groove. The same applies when the applicator is observed along the longitudinal axis of the applicator member.

Teeth of one row and teeth of another row may extend in different directions.

At least two rows may differ in at least one of the following ways: the spacing of the teeth in the row; the implantation of the teeth in the row; the number of teeth in the row; the thickness of the teeth measured perpendicularly to their long direction; the shape of the teeth; the shape of the cross-section of the teeth.

The teeth of a row may have bases that are substantially in alignment, namely that the centers of the bases of three consecutive teeth are situated substantially on a single straight line.

The implantation of the rows of teeth on the core may be substantially constant around the core along at least a fraction of the length of the applicator member. In the absence of groups of close-together rows, the term “substantially constant implantation on the core” is used to mean that the rows of teeth are distributed on the core around the longitudinal axis of said core in substantially regular manner, with substantially constant spacing between the longitudinal axes of the rows, measured over the surface of the core.

When the applicator member comprises only groups of close-together rows of teeth, the term “substantially constant implantation” should be understood to mean that the longitudinal axes of the groups of rows are disposed around the core with substantially constant spacing, measured along the surface of the core.

The term “substantially constant spacing” should be understood to mean a distance e that is constant to within 20% (i.e. e±20%), better to within 10%, better still to within 5%, or even to within 2%). For some core shapes, in particular core shapes having a cross-section that is circular or in the shape of a regular polygon, the substantially constant spacing at the surface of the core can be accompanied by substantially constant angular spacing around the longitudinal axis of the core.

In the presence of both isolated rows and groups of close-together rows, the spacing is measured along the surface of the core between the longitudinal axes of the isolated rows and the longitudinal axes of the groups of close-together rows.

The core may comprise a plurality of longitudinal faces, and the applicator may comprise rows of teeth, each extending from one of the longitudinal faces of the core.

The teeth of at least one row may be connected to the corresponding longitudinal face of the core on the same side of a middle longitudinal line of the longitudinal face of the core.

The teeth may have bases that are not centered on the longitudinal face of the core to which they are connected.

The bases of the teeth in a row may be in alignment, or they may be disposed in a staggered configuration.

For a staggered configuration, a plurality of consecutive teeth of the row may be offset at least in part, alternately on opposite sides of a geometrical separation surface. The consecutive teeth may be offset completely, alternately on opposite sides of the geometrical separation surface. The term “offset completely” should be understood as the geometrical separation surface not passing through the teeth, being a tangent to said teeth at the closest.

All of the teeth of each row may be offset alternately on opposite sides of a geometrical separation surface that is associated with the row. In a variant, the teeth may be offset on opposite sides of the separation surface, not alternately, but in groups of teeth, e.g. in groups of two or three teeth.

Still in a variant, the teeth may be offset not on opposite sides of a surface, but disposed in a pattern that is repeated along the longitudinal axis of the row, each pattern comprising three or four teeth, for example, in alignment along a line that extends obliquely relative to the axis of the row, for example.

Two consecutive teeth of a row need not be images of each other that are merely shifted in translation, in particular when the cross-sections of the teeth are non-circular in shape.

This may enable storage of composition between the teeth to be enhanced.

At least two consecutive teeth of a row of teeth may have first faces both having a common first shape, e.g. plane, at least at the bottom portion of the tooth, for example, and second faces both having a common second shape, e.g. not plane, in particular rounded. The first faces may all face in the same direction around the core, i.e. they may all face clockwise or counter-clockwise, when the core is observed along its longitudinal axis.

The first faces of the teeth, in particular when they are plane, may be connected substantially perpendicularly to the corresponding face of the core, at least for some teeth in the row. At least one tooth, or even all of the teeth, may present a plane face that is parallel to their long direction.

The cross-section of at least one tooth, or even of each tooth, may be of substantially semi-circular or semi-elliptical in shape, in other words D-shaped, or it may be of still some other shape. At least one tooth may present a cross-section that is: circular; elliptical; polygonal, in particular triangular, square, rectangular, octagonal, parallelogram-shaped, lozenge-shaped; or oval. This may impart thereto a better capacity to deform in a preferred direction. At least one tooth may present at least one portion in relief. Such a characteristic may improve the adherence of the composition to the tooth. Without changing in shape, the cross-section of the tooth may decrease on going away from the core, e.g. over more than half of the length of the tooth.

At least two teeth may be of shape that is different, e.g. of cross-section that is different, or of longitudinal section that is different. At least one tooth may be frustoconical in shape. At least one tooth may be cylindrical in shape.

The teeth may optionally be rectilinear, e.g. each extending along a long axis for the tooth that is rectilinear, or else they may be curved, or they may even be undulating. The term “longitudinal axis of the tooth” is used to mean an axis that passes via the centers of gravity of the cross-sections of the tooth.

The free ends of the teeth may define an envelope surface that may extend along a longitudinal axis that forms a non-zero angle with the longitudinal axis of the core.

The envelope surface may be of greatest transverse dimension, e.g. of diameter, that is substantially constant over at least a fraction of the length of the applicator member.

The envelope surface may be in the shape of a peanut, an American football, frustoconical, or two half-shapes selected from amongst the above-mentioned shapes and fitted together along a diametral plane containing the longitudinal axis of the core, e.g. one portion in the shape of half an American football adjacent to a portion that is frustoconical.

Each of the rows of teeth may extend on the core along a longitudinal axis of the row. The longitudinal axis of the row is a central axis for the bases of the teeth of the row, being the straight line passing via the centers of gravity of the bases of the teeth for teeth that are rigorously in alignment, and the axis passing via the separation surface for teeth that are disposed in a staggered configuration in the row.

Since the longitudinal axis of a row is considered at the surface of the core, two longitudinal axes of two successive rows, around the longitudinal axis of the core, may be separated angularly by an angle that is less than 80°, e.g. about 60°, or even less than 50°, e.g. about 45° or less. The distribution of the longitudinal axes of the rows at the surface of the core may be substantially regular, with spacing between them that is substantially constant and equal to a predefined value±20%, better±5%.

A group of close-together rows comprises a plurality of rows, e.g. two, three, or four, a tooth of one row of the group being separated from the closest tooth of an adjacent row of the group by a distance that is less than 0.8 mm, better less than 0.6 mm, better still less than 0.4 mm, e.g. by a distance that is less than the thickness of the teeth, e.g. a distance lying in the range 0.2 mm to 0.8 mm, or even in the range 0.3 mm to 0.6 mm.

The rows of a group of close-together rows are preferably parallel to one another.

Apart from the teeth of a single group of close-together rows, the applicator member may not have any teeth extending parallel to one another away from the core.

The teeth of the rows of a group of close-together rows may have the same axial positions along the longitudinal axis of the core.

The longitudinal axis of a group of close-together rows is the middle axis for the group. For example, for a group of two close-together rows, the longitudinal axis of the group is the axis that is situated mid-way between the longitudinal axes of the rows of the group.

The implantation and the distribution of the teeth on the core may be relatively regular, or even substantially constant.

Teeth may be situated along the core, around the longitudinal axis of the core, at intervals of about one every 360°/n, for example, with n lying in the range 3 to 20, better in the range 4 to 16, better still in the range 6 to 10. Such a relatively regular disposition of the teeth around the longitudinal axis of the core can enable the applicator to be used starting from any position.

The applicator member may not comprise a toothless region that extends angularly over more than one eighth of a turn, thereby making it easier to use since the user does not need to orientate the applicator too precisely relative to the eye.

By way of example, the teeth may extend in at least six different directions around the longitudinal axis of the core.

The applicator may comprise a large number of teeth, the teeth being close together so as to avoid too much composition being loaded between them, as would result from spacing that is too great.

The teeth may extend along a long axis that is perpendicular to the surface of the core from which they extend, or, in a variant, that is not perpendicular, forming a non-zero angle with the normal to the core at the base of the teeth.

In embodiments of the invention, the teeth are made with the core by molding or by overmolding.

The applicator may be made with a disposition of teeth on the core that makes it easier for the eyelashes to come into contact with the core, which may present a surface state that is perfectly defined, which is not always true of a conventional brush having a twisted core.

In an embodiment of the invention, the eyelashes may be loaded with composition that is in contact with the core. The core may thus participate in active manner in applying composition to the eyelashes, thereby offering more freedom in the choice and the arrangement of the teeth.

At least one tooth of a row may extend, at least at its portion that is connected to the core, or even over its entire length, along a first direction Z₁, perpendicular to the longitudinal face of the core to which the tooth is connected, or forming a small angle with the normal, e.g. less than 10°, better 5°. A consecutive tooth of the row may extend from the same face of the core along a second direction Z₂, at least at the portion that is connected to the core, or even over its entire length, forming an angle α with the first direction, when the core is observed along its longitudinal axis.

Substantially half of the teeth of a row may extend parallel to the first direction Z. The angle α between the directions Z₁ and Z₂ may lie in the range 5° to 80°.

The teeth may be attached perpendicularly to the core or they may be attached at an angle such that all of the teeth face in the same direction around the core, when the core is observed along its longitudinal axis. The applicator member thus need not have teeth that are oriented in opposite directions around the core. For example, when the core is observed from its distal end, all of the teeth that extend obliquely may be oriented in the clockwise direction.

The core may comprise at least one longitudinal face that is plane. In a variant, the core may comprise at least one longitudinal face that is not plane, e.g. being concave or convex, at least in part.

When observed perpendicularly to its longitudinal axis, the core may present a profile that varies. In particular, the core may present a transverse dimension that reaches a minimum in a central portion of the core, along its longitudinal axis.

At least one tooth, better each tooth of a row or of the applicator, may extend from a corresponding non-plane longitudinal face of the core in a manner that is substantially perpendicular to a plane that is tangential to the core at said tooth. For example, for a cylindrical core of circular cross-section, the teeth may extend radially.

The core may present a longitudinal face that is concave or convex in cross-section, and that has concavity or convexity that may vary along the longitudinal axis of the core.

The core may present at least one face from which teeth extend, the face presenting a width that varies along the longitudinal axis of the core.

The core may present, at a first location along the longitudinal axis of the core, a first cross-section that is substantially polygonal, and, at a second location along the longitudinal axis, a second cross-section that is substantially polygonal, at least a first vertex of the first cross-section being connected to at least a second vertex and to a third vertex of the second cross-section via respective edges, the first and second vertices being offset angularly around the longitudinal axis of the element of the applicator member.

At least one of the first and second cross-sections may be centered on the longitudinal axis of the core.

The core may present a cross-section that is substantially constant, at least over a fraction of its length. The core may also present a cross-section that varies. The cross-section of the core may pass through an extremum that is substantially mid-way along the core, the extremum being a minimum, for example. This may impart increased flexibility to the core, and makes it possible to define an envelope surface of section that varies along the applicator member, in particular when the teeth in a row are of the same length, at least over a fraction of the applicator member.

In a variant, the length of the teeth may vary along the row, such that the cross-section of the core and the cross-section of the envelope surface of the applicator member defined by the free ends of the teeth are not geometrically similar.

The envelope surface of the applicator member may present, at a first location along the longitudinal axis of the applicator member, a first cross-section that is substantially polygonal, and, at a second location along the longitudinal axis, a second cross-section that is substantially polygonal, at least a first vertex of the first cross-section being connected to at least a second vertex and to a third vertex of the second cross-section via respective edges, the first and second vertices being offset angularly around the longitudinal axis of the applicator member, at least one of the first and second cross-sections being centered on the longitudinal axis of the applicator member.

The core may present a longitudinal face that is twisted. The applicator member may present a helical distribution of the teeth on the core, oriented clockwise or counter-clockwise on going towards the distal end of the applicator member.

The applicator may comprise a single row of teeth per longitudinal face of the core.

The length of the applicator member may lie in the range about 10 mm to 48 mm, in particular in the range 15 mm to 38 mm, or even in the range 20 mm to 35 mm, e.g. being about 27 mm.

The length of the applicator member may be defined as the length of the envelope surface defined by the free ends of the teeth measured along the longitudinal axis.

The length of a row may lie in the range about 10 mm to 45 mm, in particular in the range 15 mm to 35 mm, or even in the range 20 mm to 30 mm, e.g. being about 25 mm.

When the core is observed along its longitudinal axis, it is possible to pass from one row to another by turning the core about its longitudinal axis through an integer sub-multiple of 360°, e.g. turning through 360°/n, where n is an integer that lies in the range 3 to 20, for example.

The core may extend along a longitudinal axis that, at least one point along its length, forms an angle with the longitudinal axis of a stem to which the core is fastened. The core may be bent where it connects to the stem.

The core may comprise a recess in which there is engaged a support portion, e.g. made of metal or plastics material. The core may be configured to be fastened to the support, or it may be free to turn or to move in translation relative to the support.

In a variant, the portion of the core that supports the teeth may be solid. The core may comprise a housing at one of its ends only, so as to enable it to be fastened to a stem connected to a handle.

The core may have a greatest transverse dimension, measured perpendicularly to its longitudinal axis, e.g. a diameter, lying in the range 1.2 mm to 3 mm.

The teeth may be made integrally with the core, e.g. by molding, in particular by injection-molding. The applicator member may be formed by mono-injecting material so as to form each of the portions, or by over-injecting, preferably using a thermoplastic material, which may be elastomeric, e.g. so as to form the teeth on the portions of the core. By way of example, it may be made by injection into a mold that is open on its sides in such a manner as to form the teeth. The core or a portion of the core may be made by molding with the teeth, or with a portion of the teeth, the other teeth being heat-sealed subsequently onto the core.

The mold may be formed of a plurality of shells. The number of shells may be equal to the number of rows of teeth.

In a variant, it may also be made by dual-injection, e.g. by injecting two materials simultaneously into a single mold.

The applicator member may also be made up of three different materials, e.g. one constituting only a portion of the core, and each of the other two constituting both a respective other portion of the core and its teeth.

In order to mold the applicator member, it is possible to use a thermoplastic material that is optionally relatively rigid, e.g. styrene-ethylene-butylene-styrene (SEBS); a silicone rubber; latex rubber; butyl rubber; ethylene-propylene-terpolymer rubber (EPDM); an acetate; a styrene; a nitrile rubber; a thermoplastic elastomer; a polyester, polyamide, polyethylene, or vinyl elastomer; a polyolefin such as polyethylene (PE) or polypropylene (PP); polyvinyl chloride (PVC); ethyl vinyl acetate (EVA); polystyrene (PS); polyethylene terephthalate (PET); polyoxymethylene (POM); polyamide (PA); or polymethyl methacrylate (PMMA). In particular, it is possible to use materials known under the trade names Hytrel®, Cariflex®, Alixine®, Santoprene®, Pebax®, this list not being limiting.

The two portions may differ in their chemical composition, their surface tension, their shape memory, their flexibility, and/or their hardness. One may be hard and the other soft, or one soft and the other semi-flexible. The Shore hardness of one of the portions may lie in the range 20 on the Shore A scale (ShA) to 90 on the Shore D scale (ShD), or even in the range 30 ShA to 80 ShD. By way of example, one portion may be of hardness 40 ShD, and the other portion may be of hardness 60 ShD. In another example, the first material may be a Hytrel that is white and of hardness 47 ShA, the second material being a Hytrel® that is green of hardness 63 ShA.

Preferably, the two materials are of a same chemical nature, as explained above, both being selected for example among different commercial grades of a same material of the list above.

The teeth may be made of a material that is more rigid or less rigid than a material that is used to make the stem of the applicator to which the core is connected.

At least one of the core and a tooth may present magnetic properties. By way of example, the magnetic properties may result from a filler of magnetic particles, e.g. of ferrites, that are dispersed in the plastics material of the core and/or of the tooth.

At least one of the core and a tooth may be flocked and/or may comprise a filler for improving sliding, for example.

The core may comprise a recess in which there is engaged a support portion. In a variant, the portion of the core that supports the teeth may be solid.

The applicator may comprise a stem at a first end of which the applicator member is fastened. The core may be constituted by a separate piece that is fitted to the stem of the applicator. The core may be fastened to the stem of the applicator by inserting an endpiece that extends the visible portion of the core into a housing formed at the end of the stem. In a variant, the core may comprise a housing that extends longitudinally, and into which the stem is inserted.

Still in a variant, the core may be made integrally with the stem of the applicator by molding a plastics material.

The core may be made of a plastics material that is more flexible or less flexible than the plastics material that is used to make the stem of the applicator.

By way of example, the diameter of the stem may lie in the range 3 mm to 3.5 mm.

The stem may be connected to a handle at a second end remote from the first, which handle may be configured to close, in leaktight manner, a receptacle containing the composition to be applied. The receptacle may comprise a wiper member that may be adapted to wipe the stem and the applicator member.

The applicator may be free of any metal, thereby making it possible to put it in a microwave oven.

Where appropriate, the core may have a hollow inside, and it may comprise at least one channel via which the composition can pass through the applicator member.

The invention also provides a packaging and applicator device for applying a composition to keratinous fibers, in particular the eyelashes or the eyebrows, the device comprising an applicator as defined above, and a receptacle containing the composition. The handle of the applicator may constitute a closure cap for closing the receptacle.

The composition may be a water-resistant mascara.

The invention also provides a method of applying makeup to the eyelashes or the eyebrows by means of an applicator as defined above.

The invention also provides a method of manufacturing a molded applicator member for combing the eyelashes and/or the eyebrows, and/or for applying a composition to the eyelashes and/or the eyebrows, the applicator member comprising a core and teeth, the method comprising the following steps:
injecting a first material for molding a first portion of the applicator member including teeth; and
injecting a second material for molding a second portion of the applicator member including teeth.

During injection, the second material may pass through openings in the first portion.

The final configuration of the applicator member may be obtained at the time of injection, or, in a variant, successively over time during injection.

The invention can be better understood on reading the following detailed description of non-limiting embodiments thereof, and on examining the accompanying drawings, in which:

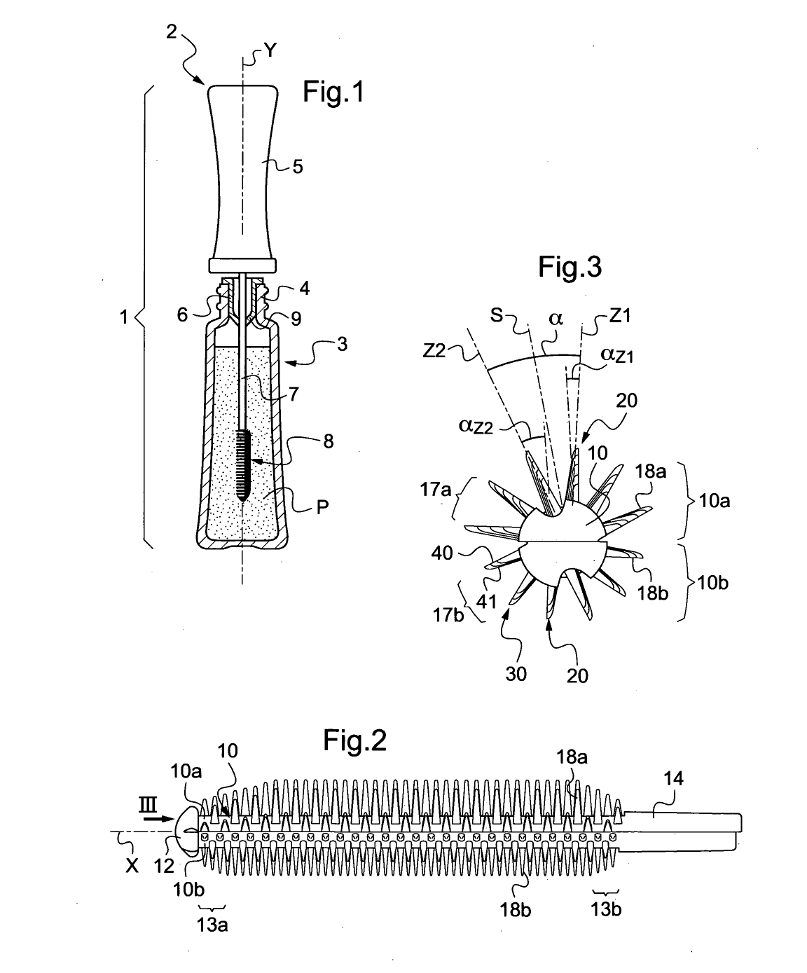

FIG. 1 is a diagrammatic and fragmentary longitudinal section view in elevation showing an example of a device made in accordance with the invention;

FIG. 2 is a side view of the FIG. 1 applicator member shown in isolation;

FIG. 3 is a view as seen looking along arrow III in FIG. 2;

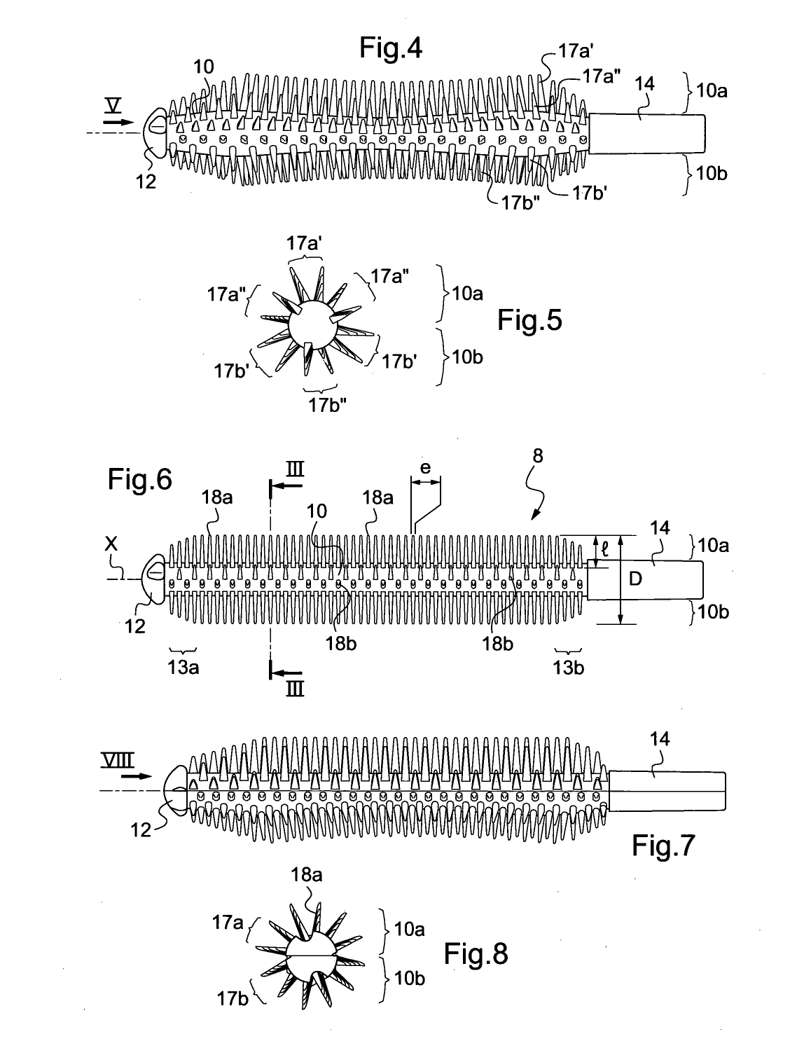

FIGS. 4 & 5, and 6, 7 & 8 are views similar to FIGS. 2 and 3 of variant embodiments;

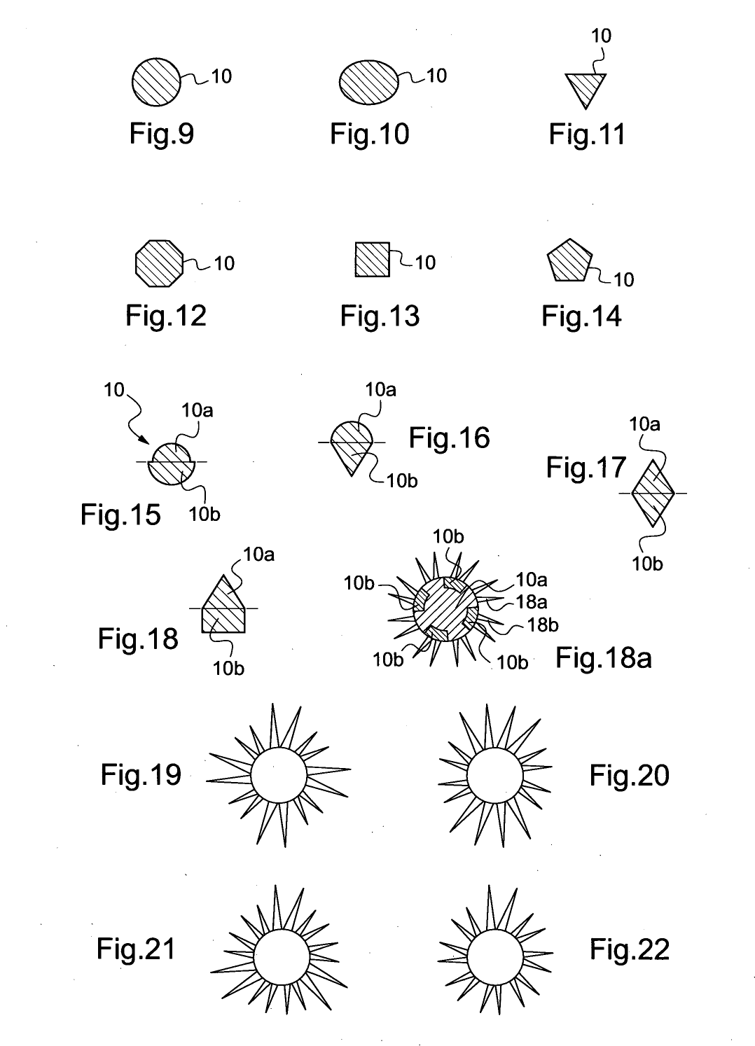

FIGS. 9 to 18, 18a, 27a, 28a, 30, and 32 are diagrammatic and fragmentary cross-sections of variant embodiments;

FIGS. 19 to 22 are views similar to FIG. 3 showing variant embodiments;

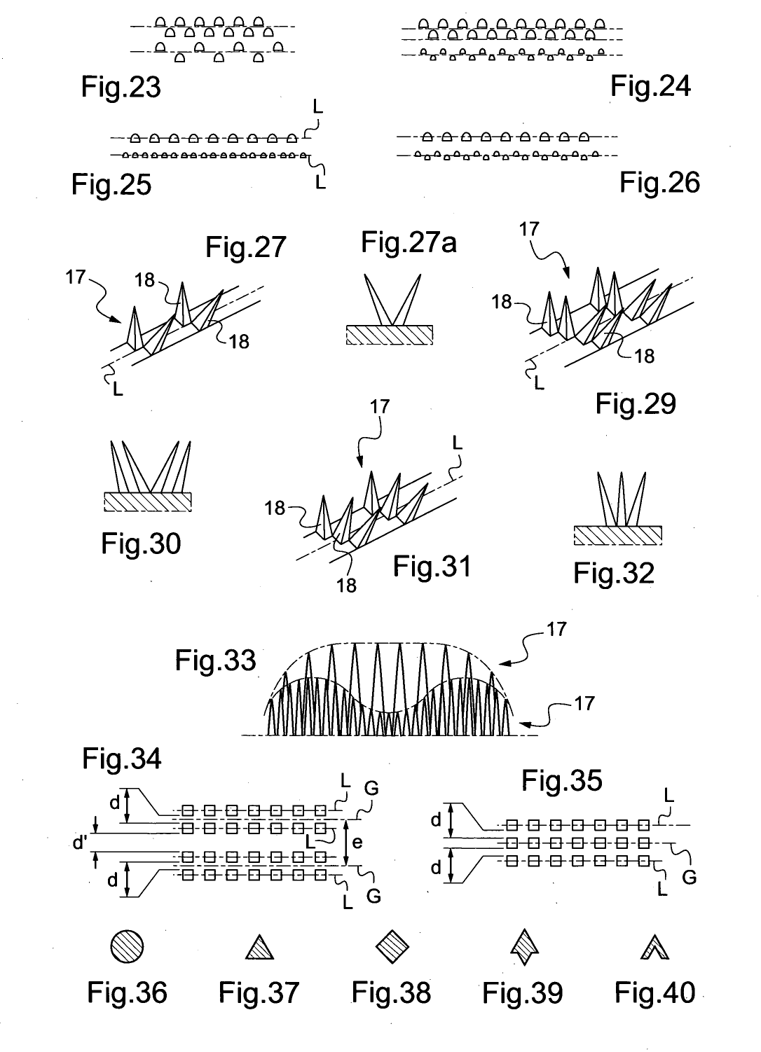

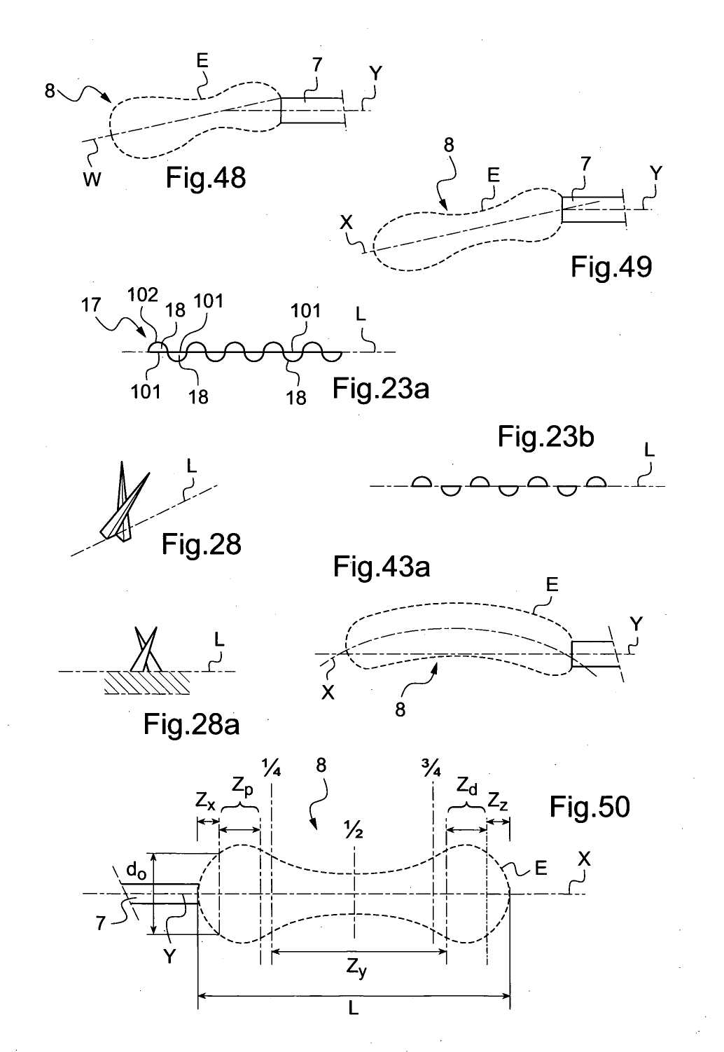

FIGS. 23, 23a, 23b, 24 to 26, 34, and 35 are diagrammatic and fragmentary views showing arrangements of teeth;

FIGS. 27, 28, 29, and 31 are fragmentary perspective views of variant embodiments;

FIG. 33 is a diagrammatic and fragmentary side view of a variant embodiment;

FIGS. 36 to 40 are cross-sections of teeth;

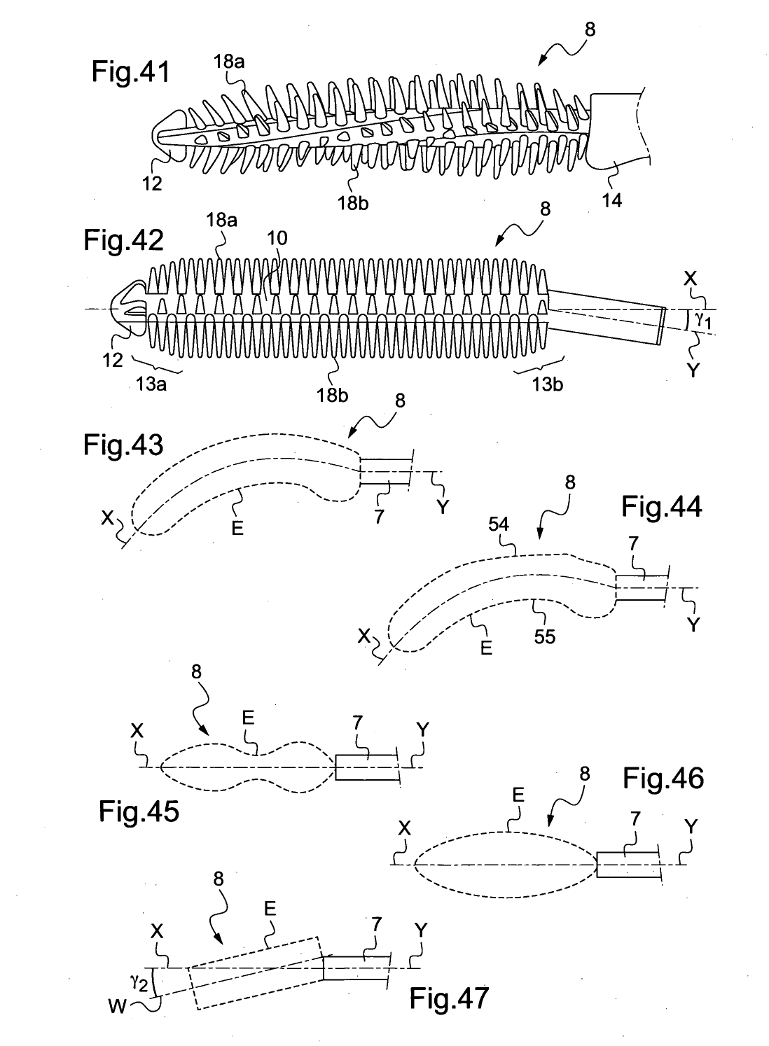

FIG. 41 is a perspective view of a variant embodiment;

FIG. 42 is a view similar to FIG. 2 showing another variant;

FIGS. 43, 43a, 44 to 49 are diagrams of envelope surfaces of other variant embodiments;

FIGS. 50 to 56 show examples of envelope surfaces;

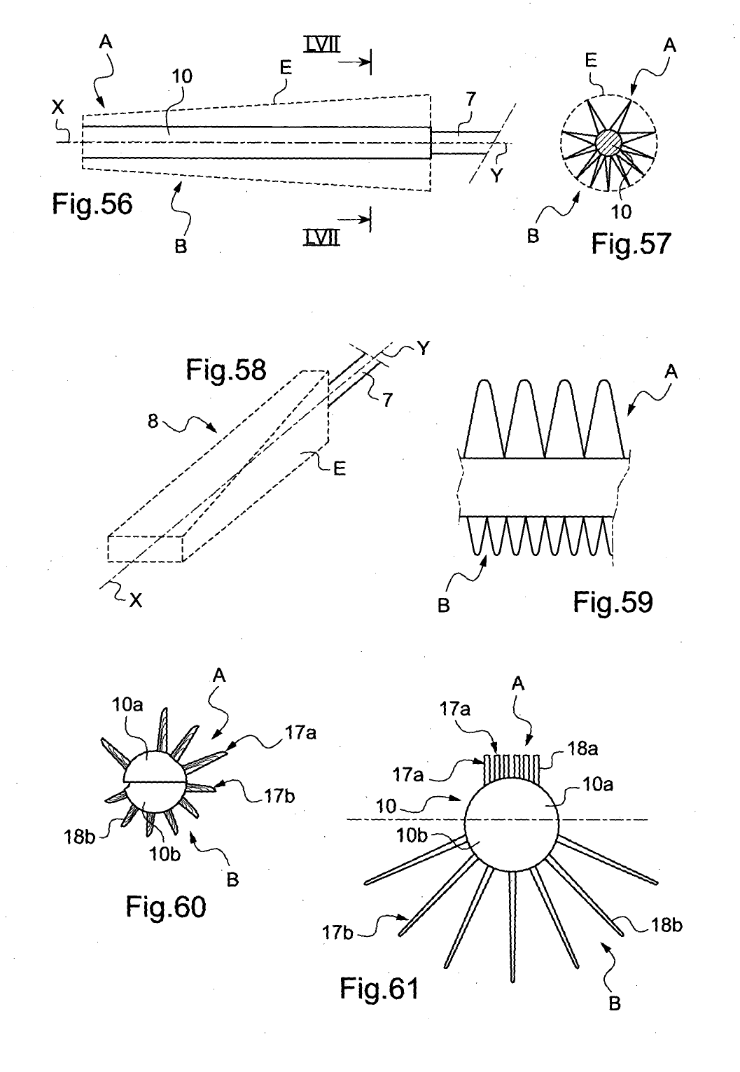

FIG. 57 is a cross-section on LVII of FIG. 56;

FIG. 58 shows another example of envelope surface;

FIG. 59 shows the possibility of having different numbers of teeth on either side of the core;

FIGS. 60 and 61 are face views of various embodiments of the applicator member.

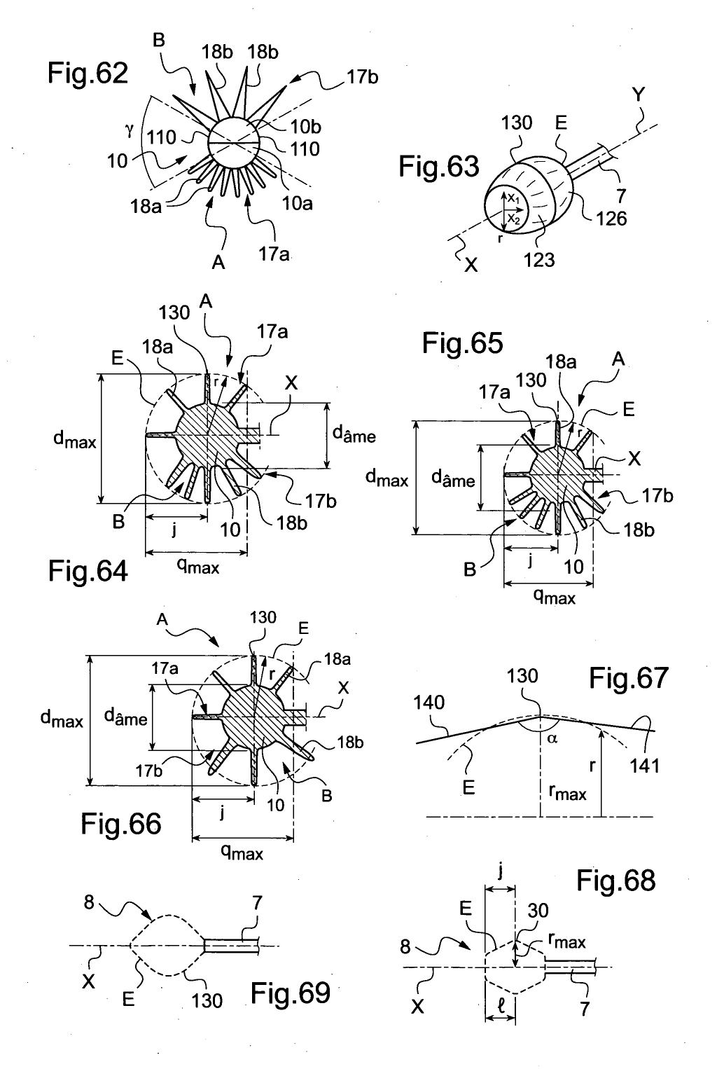

FIG. 62 is a diagrammatic cross-section of a variant embodiment of the applicator member;

FIG. 63 is a diagram showing the envelope surface of a variant embodiment of the applicator member;

FIGS. 64 to 66 are diagrammatic longitudinal sections showing various embodiments of the applicator member;

FIG. 67 shows an embodiment detail;

FIGS. 68 to 71 show other examples of envelope surfaces for the applicator member;

FIG. 72 is a fragmentary longitudinal section of a variant embodiment;

FIGS. 73 to 75 show variant embodiments of teeth;

FIG. 76 is a diagrammatic and fragmentary cross-section of a variant embodiment of the wiper member; and

FIGS. 77 and 78 show details of variant embodiments of the stem. FIG. 1 shows a packaging and applicator device made in accordance with the invention, the device comprising an applicator 2 and an associated receptacle 3 containing a composition P for application to the eyelashes and/or the eyebrows, e.g. mascara or a care product.

By way of example, the applicator 2 of the invention makes it possible to use a water-resistant mascara.

In the embodiment under consideration, the receptacle 3 comprises a threaded neck 4, and the applicator 2 comprises a closure cap 5 that is arranged to be fastened on the neck 4 so as to close the receptacle 3 in leaktight manner when not in use, the closure cap 5 also constituting a handle for the applicator 2.

The applicator 2 comprises a stem 7 of longitudinal axis Y, which stem is connected at its top end to the closure cap 5, and at its bottom end to an applicator member 8.

The receptacle 3 also comprises a wiper member 6 that is inserted in the neck 4.

In the embodiment under consideration, the wiper member 6, that can be of any type, comprises a lip 9 that is arranged to wipe the stem 7 and the applicator member 8 while the applicator 2 is being removed from the receptacle 3. The lip 9 defines a wiper orifice of diameter that is adapted to the diameter of the stem.

In the embodiment shown, the stem 7 presents a cross-section that is circular, but it is would not be beyond the ambit of the present invention for the stem 7 to present some other section, the cap 5 thus possibly being fastened on the receptacle 3 other than by screw-fastening, if necessary. The wiper member 6 could be adapted to the shape of the stem 7 and to the shape of the applicator member 8, where appropriate.

In the embodiment under consideration, the longitudinal axis Y of the stem 7 is rectilinear and coincides with the longitudinal axis of the receptacle 3 when the applicator 2 is in place thereon, but would not be beyond the ambit of the present invention for the stem 7 to be non-rectilinear, e.g. forming a bend.

Where appropriate, the stem 7 can comprise an annular narrowing at its portion that comes to be positioned facing the lip 9 of the wiper member 6, so that said wiper member is not mechanically stressed unduly during storage.

With reference to FIGS. 2 and 3, it can be seen that the applicator member 8 comprises a core 10 of elongate shape, extending along a longitudinal axis X.

The core 10 comprises a first portion 10a and a second portion 10b that is opposite the first portion, each of the portions 10a and 10b extends along the longitudinal axis X of the core. The portions 10a and 10b differ in the material from which they are constituted, the first portion 10a being molded out of a first material, and the second portion 10b being molded out of a second material that is different from the first material.

In the embodiment under consideration, over the majority of its length, the core 10 presents a cross-section that is polygonal, having sides that define longitudinal faces 15. In the embodiment described, the faces 15 are plane. The longitudinal axis X is central.

In the embodiment described, the longitudinal faces 15 are six in number, the cross-section of the core being substantially hexagonal. In the embodiment under consideration, each of the portions 10a, 10b constitute half of the applicator, with each defining three longitudinal faces 15 and being symmetrical to each other about a plane containing the longitudinal axis X of the core.

In the embodiment shown, a single row 17 of teeth 18 is connected to each of the longitudinal faces 15. In the embodiment under consideration, the teeth 18 are made integrally with the core 10 by molding thermoplastic material. More precisely, in the embodiment described, each of the teeth 18a, connecting to the first portion 10a of the core 10, is made out of the same material as the portion 10a, and, likewise, each of the teeth 18b, connecting to the second portion 10b of the core 10 is made of the same material as the second portion of the core.

Naturally, it would not be beyond the ambit of the present invention if this were otherwise, and the teeth 18a and 18b could be made out of materials that are different from each other, and that also differ from the materials constituting the portions 10a and 10b of the core.

Thus, the teeth and the core can be made out of different materials.

At its distal end 12, the applicator member 8 can comprise a head that tapers forwards so as to make it easier to put the applicator 2 back into the receptacle 3. The height of the teeth 18 can decrease on going towards the head 12, along a distal transition portion 13a, as shown in FIG. 2.

The height of the teeth 18 can also decrease along a proximal transition portion 13b on going towards the stem 7, so as to make it easier for the applicator member to pass through the wiper member 6 while the applicator 2 is being removed.

The head 12 can be circularly symmetrical, or it can comprise radial fins, as shown in FIG. 2, or it can have still some other shape, or it can even not exist.

In the embodiment under consideration, the core 10 is extended from its proximal end by a cylindrical endpiece 14 that enables it to be fastened onto the stem 7. In particular, fastening can be performed by molding, welding, force-fitting, snap-fastening, adhesive, heat-sealing, or crimping in a housing provided at the end of the stem. In a variant, the stem can be inserted into a housing provided in the core.

The core 10 can also be molded integrally with the stem 7.

The rows 17 of teeth 18 comprise first rows 17a of teeth 18a that extend from the first portion of the core 10a, and second rows 17b of teeth 18b that extend from the second portion 10b of the core.

In the embodiment described with reference to FIGS. 1 to 3, in addition to their material, the teeth 18a and 18b of the first and second rows 17a, 17b, differ in particular in their length, the teeth 18a being longer than the teeth 18b. In addition, the rows 17a and 17b also differ in the spacing of the teeth 18a, 18b in the row, the teeth 18a being more spaced apart in the rows 17a than the teeth 18b in the rows 17b.

As a result, the applicator member comprises a greater number of teeth 18b than teeth 18a, although the number of first rows 17a is equal to the number of second rows 17b.

An example of a configuration of a row 17 of teeth 18 is described more precisely below, the description applying equally well, in an embodiment of the invention, to the rows 17a of the first portion 10a, as to the rows 17b of the second portion 10b.

The row of teeth may be configured as described in US 2008/0023020.

Each row 17 of teeth 18 comprises a first set 20 of first teeth that are connected to the corresponding face 15 of the core 10 while forming an angle α₁ relative to the normal thereto, and a second set 30 of teeth that are connected to the face 15 obliquely, forming an angle α_{z2} relative to said normal.

The teeth 18 of the first set 20 of teeth are straight, extending along a direction Z₁ that is substantially perpendicular to the face 15, the angle α_{z1} being relatively small, e.g. less than 10°, or even less than 5°.

The teeth 18 of the second set 30 of teeth are also straight in the embodiment under consideration, extending along a direction Z₂, forming an angle α with the direction Z₁.

By way of example, the angle α can lie in the range 20° to 80°.

In FIG. 3, it can be seen that each row comprises teeth having a face that is connected perpendicularly to the corresponding longitudinal face 15.

In the embodiment described, the teeth 18 of each row 17 are disposed in a staggered configuration. Two consecutive teeth 18 of each row 17 are offset alternately on opposite sides of a separation surface S, the surface S being a bisector plane of the angle α.

The teeth of the first set 20 are disposed on one side of the separation surface S, while the teeth of the second set 30 are disposed on the other side of said separation surface, when the core 10 is observed along its longitudinal axis.

Within each row 17, the bases of the teeth of the first set 20 and of the second set 30 are not in alignment, since they are respectively situated entirely on opposite sides of the separation surface S.

In the embodiment shown, the teeth of the first set 20 and of the second set 30 do not overlap, when the applicator member is observed from the side along a direction that is perpendicular to the axis X, as shown in FIG. 2.

In the embodiments shown, it can be seen in FIGS. 2 and 3 that each tooth 18 of the first set 20 of a row 17 can be associated with a respective tooth of the first set 20 of another row 17, substantially occupying the same axial position along the axis X of the core, the passage from one tooth to another being performed by turning about the axis X through a sub-multiple of 360°, in this event 60°. The same applies for each tooth 18 of the second set 30.

The oblique teeth 18 of the various rows face in the same direction around the core, i.e. the clockwise direction in FIG. 3.

In the embodiment shown in FIGS. 1 to 3, the faces 15 are plane and the teeth of a row 17a, 17b all have the same length, at least in a central portion of the applicator member, such that an envelope surface of the applicator member defined by the end of the teeth 18a, 18b is cylindrical, at least in a central portion of the applicator member.

Naturally, it would not be beyond the ambit of the present invention if this were otherwise, and if the faces 15 of the core were, for example, concave in the central portion, as shown in FIGS. 4 and 5. In this embodiment, the core 10 comprises longitudinal faces 15 that are concave at least in part, the concave shapes being centered on a mid-plane of the core 10, e.g. intersecting said core substantially half-way along.

The concave shapes of the longitudinal faces 15 can be formed by a narrowing of the cross-section of the core 10.

In this embodiment, all of the teeth of a row also have the same length, at least in a central portion of the applicator member, such that, also in a central portion of the applicator member, the envelope surface presents concavity that is hour-glass shaped.

The teeth 18a and the teeth 18b of the first portion 10a and second portion 10b of the applicator member 8 shown in FIGS. 4 and 5 differ in their material, as in the embodiment shown in FIGS. 1 to 3.

Furthermore, each of the portions 10a and 10b comprises rows 17a′, 17b′ of long teeth, and rows 17a″, 17b″ of short teeth, such that the applicator member comprises three rows of long teeth and three rows of short teeth in alternation with one another. The angular extent of the long teeth is equal to the angular extent of the short teeth.

In the embodiment described, the rows 17a′ and 17b′ of long teeth and the rows 17a″ and 17b″ of short teeth are equal in number, but it would not be beyond the ambit of the present invention if this were otherwise, and if the applicator member were, for example, to comprise a number of rows of long teeth that was different from the number of rows of short teeth, e.g. twice the number. By way of example, the applicator member comprises four rows of long teeth distributed in groups of two rows, in alternation with two rows of short teeth.

In another variant embodiment, all of the teeth connected to the two portions 10a and 10b can also be identical, at least in a central portion of the applicator member, as shown in FIG. 6. In this embodiment, the teeth have a length l that is less than 1.8 mm and greater than 0.5 mm, at least for more than half of them. They have a greatest thickness e lying in the range 0.2 mm to 0.65 mm.

In addition, a greatest transverse dimension D of the applicator member may be less than or equal to 7 mm, better less than or equal to 6 mm, better less than or equal to 5.7 mm. In this embodiment, all of the rows are identical and differ only in the material used to make the first and second rows.

In the embodiment shown in FIGS. 7 and 8, the two portions 10a and 10b differ from each other in the concavity of their faces 15, the faces 15 of the portion 10a being plane, while the faces 15 of the portions 10b are concave.

The portions 10a and 10b of the various embodiments described above can be combined with one another.

As a result, it should be understood that any combination of applicator-member portions are possible, enabling a wide range of different applicators to be made, e.g. with a small number of half-shells assembled together in groups of two to form the mold, thereby reducing the cost of manufacturing applicator members and increasing makeup possibilities, or even by simultaneously injecting at least two different materials into a single mold.

In all of the above-described embodiments, the core comprises six longitudinal faces and has a cross-section that is of hexagonal shape.

The core can comprise any number of longitudinal faces, with it being possible for any of the above-described characteristics to apply regardless of the number of longitudinal faces.

In a variant, the core can thus present a cross-section that is circular, as shown in FIG. 9, or oval, as shown in FIG. 10, or even triangular, octagonal, square, or pentagonal, as shown in FIGS. 11, 12, 13, and 14 respectively.

The core 10 can also comprise two halves having shapes that are different, in particular having cross-sections that are different, with each of the two halves constituting an applicator-member portion, and said portions being optionally made out of materials that are different, being offset angularly around the longitudinal axis of the core, for example.

In the embodiment shown in FIG. 15, they are both semi-circular but of radii that are different. In the embodiment shown in FIG. 16, one is semi-circular and the other is triangular. In the embodiment shown in FIG. 17, both are triangular, and in the embodiment shown in FIG. 18, one is triangular and the other is rectangular.

By observing the cross-section of the core, it is possible to see the distribution of the two materials constituting the first and second portions 10a, 10b of the core of the applicator member.

In the embodiment shown in FIG. 18a, each of the two materials is encountered successively around the surface of the core of the applicator member, the material constituting the first portion 10a having been injected into openings in the second material constituting the second portion 10b. In this embodiment, the teeth 18a are made out of the same material as the first portion 10a of the core, and the teeth 18b are made out of the same material as the material constituting the second portion 10b of the core. This could be otherwise and some of the teeth could be constituted by a third material, for example.

In the embodiments shown in FIGS. 1 to 8, the applicator member 8 comprises six rows of teeth 17, but it would not be beyond the ambit of the present invention for it to comprise more, e.g. eight or nine as shown in FIGS. 19 to 22.

In the embodiment shown in FIG. 19, the rows of long teeth alternate with the rows of short teeth, a row of long teeth succeeding a row of short teeth around the longitudinal axis of the applicator member 8.

In the embodiment shown in FIG. 20, the rows of long teeth are grouped together in groups of two and the same applies for the rows of short teeth, such that two rows of long teeth alternate with two rows of short teeth around the longitudinal axis of the applicator member 8.

Finally, in the embodiment shown in FIG. 21, two rows of short teeth alternate with one row of long teeth, such that the applicator member comprises three rows of long teeth and six rows of short teeth.

In addition, the applicator member can comprise only a single row of long teeth and a plurality of rows of short teeth, as shown in FIG. 22.

In all of the embodiments, each of the two portions 10a and 10b can comprise one or more of the rows described.

An applicator member 8 of the invention can comprise more than two visible teeth per longitudinal face, when the core is observed along its longitudinal axis, and, in addition to the first and second teeth 18 of the sets 20 and 30, can comprise one or more additional teeth 18, e.g. forming an angle β that is greater than α with the direction Z₁, or even extending perpendicularly to the face of the corresponding core.

It would not be beyond the ambit of the present invention for the teeth of the second set 30 of teeth not to slope relative to the longitudinal face 15 of the core to which they are connected, and for the directions Z₁ and Z₂ to be parallel for each row 17.

The teeth of two rows can have different spacing within the row, as shown in FIG. 23, or two rows can differ in the thickness of the teeth, as shown in FIG. 24.

Within a row 17, the consecutive teeth 18 may present respective first faces 101 that are substantially plane. The opposite faces 102 of the teeth may be in the form of half a cone or half a pyramid, for example. The teeth 18 may be oriented in alternation with their faces 101 facing towards the midplane of the row and outwards from the row, as shown in FIG. 23a. Such a disposition of the teeth can make it easier to mold the row of teeth, since all of the teeth having their faces 101 facing in a given direction are molded by the same mold shell, while all of the other teeth of the row, having their faces 101 facing in the opposite direction are molded by another mold shell. These two mold shells come into contact with each other.

The teeth 18 may touch to a greater or lesser extent within the row, as shown in FIGS. 23a and 23b. In particular, the teeth 18 may be substantially touching as shown in FIG. 23a, i.e. in contact or with small spacing between one another, e.g. spacing less than or equal to 0.1 mm at their bases. The disposition of the bases of the teeth shown in FIGS. 23a and 23b can be applied to all of the applicator members described in the present application. In the embodiments described above, the teeth of the first and second sets 20 and 30 of teeth 18 are disposed in a staggered configuration, with their bases not being in alignment.

As shown in FIG. 25, this could be otherwise and the bases of the teeth 18 could be in alignment, on a common line L that is parallel to the longitudinal axis X of the core 10 intersecting all of the bases of the aligned teeth of the row.

In addition, FIG. 25 shows rows in which the teeth are spaced apart differently and are of different thicknesses.

In the embodiment in FIG. 26, one row comprises teeth that are in alignment, and the other row comprises teeth that are disposed in a staggered configuration.

In the preceding embodiment, one or the other of the rows can be a row of one or the other of the first and second portions.

When the applicator is observed perpendicularly to its longitudinal axis, two consecutive teeth of a row can define a V-shaped groove, as shown in FIG. 27.

When the applicator member is observed along its longitudinal axis, two consecutive teeth of a row can also form a V-shape, as shown in FIG. 27a.

Two consecutive teeth of a row may cross when the row is observed along its longitudinal axis L, as shown in FIG. 28.

In a variant, two consecutive teeth of a row may cross when the row is observed perpendicularly to its longitudinal axis L, as shown in FIG. 28a, the two crossing teeth then being directed respectively towards the proximal end and towards the distal end of the applicator member. It can be seen in FIGS. 29 and 30 that, within a row, the applicator may comprise patterns of four teeth, of which the middle teeth form a V-shape. The four teeth succeed one another along the longitudinal axis of the row. The teeth are not contained in a single plane, perpendicular to the longitudinal axis of the core.

In the embodiment shown in FIGS. 31 and 32, the row comprises patterns of three teeth, of which two teeth form a V-shape with a central tooth between them.

Within each row, the teeth could be grouped together, e.g. in groups of two. Naturally, the teeth could be grouped together other than in pairs, the spacing between the groups of teeth within the same row optionally being uniform, and for example greater than the average spacing between the teeth within a group.

A plurality of rows of sufficiently close-together teeth can form a group of close-together rows, extending along a longitudinal axis G that is parallel to the longitudinal axes L of each of the rows, and that is central relative to said rows.

By way of example, FIG. 34 shows two groups of two close-together rows, and FIG. 35 shows one group of three close-together rows. The longitudinal axis G of the groups of close-together rows is situated at equal distances from the two longitudinal axes L of the two extreme rows of the group of close-together rows.

The closest teeth of two adjacent rows of the same group of close-together rows are spaced-apart by a distance d that is less than 0.8 mm, the distance possibly being less than the thickness of a tooth, or even zero, the teeth of the two close-together rows thus being touching. The teeth of two different groups of close-together rows can be spaced-apart on the core by a distance d′ that is much greater than d, e.g. more that twice, or even three times d.

In addition, when observed perpendicularly to the longitudinal axis of the core, an applicator member can comprise rows of teeth having profiles that are identical, as shown in FIGS. 1 to 3, or that are different, as shown in FIG. 33.

In the FIG. 33 embodiment, the two rows of teeth 17 have different profiles, one being in the shape of a camel's back, presenting a central concavity, and the other presenting a central flat.

In addition, in the embodiments under consideration, each tooth 18 comprises a first longitudinal face 40 of plane shape and a second longitudinal face 41 of rounded shape, in particular of convex shape.

In a variant, at least one tooth can have a cross-section that is circular, as shown in FIG. 36, or even triangular, as shown in FIG. 37, or lozenge-shaped, as shown in FIG. 38, or even formed of two different-size adjacent triangles, as shown in FIG. 39, or triangular with a groove, as shown in FIG. 40.

In a variant embodiment, the longitudinal faces 15 of the core 10 are twisted, as shown in FIG. 41, i.e. the corresponding side turns through at least one turn towards the distal end of the core.

The core 10 can be deformed on unmolding by turning the endpiece 14, or, in a variant, it can be deformed in the mold.

The longitudinal axis X of the core 10 can coincide with the longitudinal axis Y of the stem 7, but it would not be beyond the ambit of the present invention for this to be otherwise, and, by way of example, FIG. 42 shows a variant embodiment in which the longitudinal axis X of the core 10 forms an angle γ₁ with the longitudinal axis Y of the stem. Such a configuration can improve application by making it easier to manipulate the applicator.

The core can extend along a longitudinal axis X that is not rectilinear. FIG. 43 shows a variant embodiment in which the core extends along a longitudinal axis X that is curved. When observed in longitudinal section, as in FIG. 43, the envelope surface E can, on one side of the axis X, present a convex first outline 54 that extends substantially in the same direction as the axis X, and, on the opposite side of the axis X, a concave second outline 55 that extends substantially in the same direction as the axis X.

The distal end of the envelope surface may optionally be aligned with the longitudinal axis of the stem. In FIG. 43a, there can be seen the possibility for the distal end of the envelope surface E to be in alignment with the longitudinal axis Y of the stem 7. In the variant shown in FIG. 44, the envelope surface E presents two opposite outlines 54 and 55, of which one 54 is straight.

The applicator member may present a variety of shapes for its envelope surface E. In a variant shown in FIG. 45, the envelope surface E presents a cross-section that passes via a minimum. The axis X coincides with the axis Y.

In the variant shown in FIG. 46, the longitudinal axis X of the core 10 is rectilinear, and the envelope surface E presents an ovoid shape, in other words an American-football shape.

In another variant, shown in FIG. 47, the free ends of the teeth 18 define an envelope surface E that extends generally along a longitudinal axis W that forms an angle γ₂ with the longitudinal axis X of the core 10, where such an applicator member could be said to be excentric.

The FIG. 48 variant differs from the FIG. 47 variant in the shape of the envelope surface E that presents a cross-section that passes via a minimum.

The longitudinal axis X of the core 10 can be rectilinear and can form an angle with the longitudinal axis Y of the stem 7, as shown in FIG. 49, the envelope surface E having, for example, a cross-section that is not constant, e.g. passing via a minimum.

The envelope surface E may be generally peanut-shaped, as shown in FIG. 50. The envelope surface may in particular present two portions of larger cross-section in the vicinities of its proximal and distal ends, with an intermediate portion of smaller cross-section.

For example, it is possible to have portions of larger cross-section with a maximum transverse dimension greater than or equal to 6 mm in zones zₚ and z_{d}, these zones respectively lying between the proximal end of the envelope surface and the first quarter of its length and the distal end of the envelope surface and the first quarter of its length going towards the proximal end.

When the envelope surface is a surface of revolution, the zones zₚ and z_{d} may for example be of diameter greater than or equal to a value d₀ that is equal to 6 mm, for example.

By way of example, the cumulative length of the portions zₓ, z_{y}, and z_{z} inscribed in a cylinder having a diameter of 6 mm occupies more than 70% of the total length L of the applicator member. The maximum diameter in the zones zₚ, z_{d} is equal to 6.4 mm, for example, and the minimum diameter in the central portion is equal to 5.4 mm, for example.

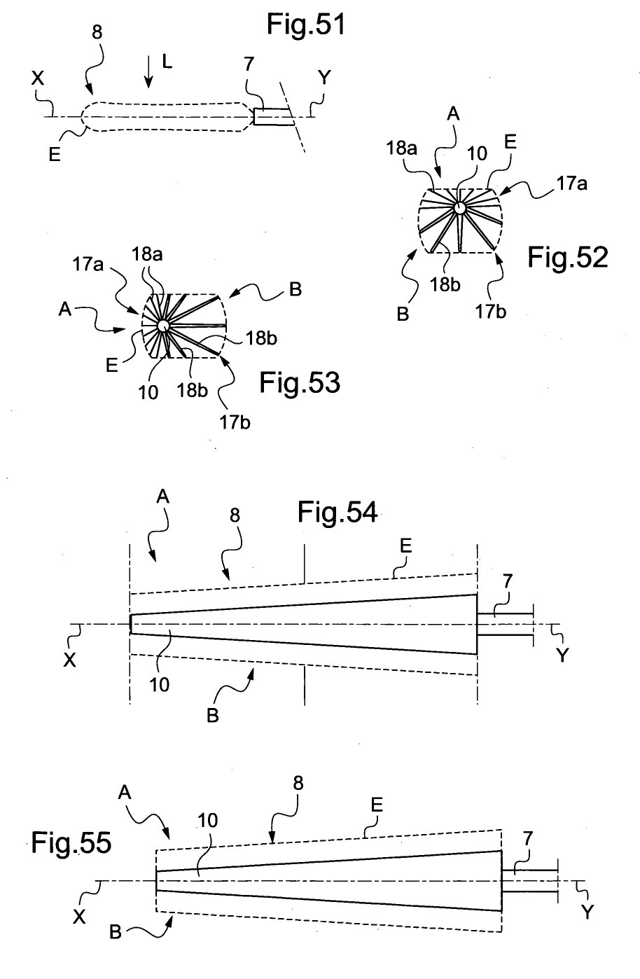

The applicator member may have an envelope surface of varying cross-section, with two portions close to the proximal and distal ends that are not surfaces of revolution about the longitudinal axis of the core. In FIG. 51, there can be seen an applicator member that, when observed from the side along arrow L in FIG. 51 presents, by way of example, the shape shown in FIG. 50, and when it is observed from above presents a flat shape as shown in FIG. 51.

The core 10 may be centered relative to the envelope surface E or it may be off-center relative thereto, as shown in FIGS. 52 and 53. In these examples, it can be seen that the envelope surface E presents a shape in cross-section in a section plane perpendicular to the longitudinal axis X that is generally flat with two opposite faces that are plane and parallel and interconnected by two faces that are outwardly convex.

By way of example, the core 10 is closer to one of the plane faces of the envelope surface than to the other plane face, as shown in FIG. 52, or in a variant it is closer to one of the convex faces of the envelope surface than to the other, as shown in FIG. 53.

In addition to the shape described above, the applicator member may present an envelope surface E that is generally frustoconical in shape, as shown in FIGS. 54 to 56.

The envelope surface E may have a larger diameter of 7 mm, at its proximal end and a smaller diameter of 4.5 mm at its distal end.

The envelope surface E may be centered on the longitudinal axis X of the applicator member core, as shown in FIG. 54, which axis may also coincide with the longitudinal axis Y of the stem 7, as also shown in this figure.

The core 10 may also be generally frustoconical in shape, as can be seen in FIGS. 54 and 55, or it may be in the form of a cylindrical body of revolution as shown in FIG. 56, or it may have some other shape.

FIG. 55 shows the possibility of the axis of the envelope surface E not coinciding with the axis of the core, e.g. being parallel thereto. In the example of FIG. 4, there can be seen by way of example a larger number of rows of teeth extending longitudinally parallel to the axis X on the side of the face A of the applicator member than on the side of the opposite face B, and/or rows having greater numbers of teeth within each row, and/or teeth having thicknesses that differ from the thicknesses of teeth carried by the opposite portion of the core.

In the example of FIG. 55, by way of example, beside the face A there are teeth that are longer than the teeth beside the face B, e.g. having a number of teeth per longitudinal row that differs for each of the faces A and B.

In the example of FIG. 56, and as can also be seen in FIG. 57, it is possible to have a larger number of rows of teeth beside the face B, e.g. with teeth beside the face B being finer than the teeth beside the face A, there being a larger number of teeth within each row, for example.

In the embodiment of FIG. 58, the envelope surface E is of rectangular cross-section, and it presents four longitudinal edges. The rectangle formed by the distal end face is offset by 90° relative to the rectangle formed by the proximal end face, such that the rectilinear edges interconnect the two long sides of the rectangle formed by the distal end face to the two short sides of the rectangle formed by the proximal end face, and vice versa.

In accordance with one of the aspects of the invention, the rows of teeth carried by the first portion of the core may have a number of teeth within the row that differs from the number of teeth within rows of teeth carried by the second portion of the core, as shown in FIG. 59.

The rows may not only have different numbers of teeth per row, but the teeth may also be of different heights and/or thicknesses, as also shown in said figure.

In FIG. 60, there can be seen the possibility of having one or more rows of teeth on one of the sides A or B of the applicator member that are missing compared with a regular arrangement of rows of teeth on that side of the applicator member.

FIG. 60 shows that a row of teeth is missing close to one of the extreme rows of the set of rows 17a. In other rows, the rows 17a are spaced apart from one another at an angular pitch that is constant, except that two of them are spaced apart at twice that angular pitch, for example.

In numerous embodiments, on each of the sides A and B of the applicator member, the rows of teeth extend in at least three different directions about the longitudinal axis of the core. This is not necessarily so, and by way of example, FIG. 61 shows an applicator member for which the teeth on the side A are all parallel, whereas on the opposite side B, the rows of teeth extend in different directions. This figure also shows that the length of the teeth respectively associated with the sides A and B are different. The same can apply to the numbers of teeth within each row 17a or 17b, and to the thicknesses of the teeth, or indeed to the materials from which the teeth are made.

The applicator member may present side surfaces 110 that do not have any teeth between the faces A and B, as shown in FIG. 62. By way of example, each side surface 110 extends, as can be seen in the figure, between one of the end rows 17b of the set of rows 17b and the end row 17a of the set of rows 17a that is adjacent thereto. By way of example, the angular extent γ of a side surface 110 lies for example in the range 0 to 60°, not including the limit of 0.

FIGS. 63 to 71 relate to applicators for applying a composition to keratinous fibers, in particular the eyelashes and/or the eyebrows, the applicators comprising a molded applicator member, comprising:
a stem;
a core that extends along a longitudinal axis;
teeth carried by the core, the distal end of the applicator being defined by the core or by at least one tooth; and
teeth extending in at least three different directions around the core and defining an envelope surface that grows to a maximum and then decreases in cross-section towards the free end of the applicator.

In accordance with the invention, such applicators may present different application faces A and B, e.g. differing in number of teeth, e.g. in number of teeth per row, in tooth thickness, in tooth material, and/or in tooth length.

The total length qₘₐₓ along the longitudinal axis of the envelope surface may be less or equal to twice the greatest diameter dₘₐₓ of the cross-section of the envelope surface, better 1.75 times the maximum diameter, better still 1.5 times or 1.25 times.

The angle α formed by the slope of the envelope surface in at least one longitudinal section on either side of the maximum may be greater than or equal to 120°, better 130°, better still 135°.

The term “diameter dₘₐₓ” should be understood as meaning the transverse dimension of the envelope surface, even if the cross-section does not present an outline that is circular.

The term “total length qₘₐₓ” should be understood as the total length of the envelope surface as defined by the teeth, and as measured along the longitudinal axis of the core. The angle α is the angle formed by the slopes of the envelope surface on either side of the maximum, as shown in FIG. 67. These slopes may be straight lines providing the best fit to the envelope surface on either side of the maximum. They may be tangential to a portion of the envelope surface adjacent to the maximum, this portion extending for example over a length as is measured along the longitudinal axis of the core that is equal to 1 mm. The slopes may also be straight lines passing through the maximum and intersecting the envelope surface at a distance from the maximum as measured along the longitudinal axis of the core that is equal to 1 mm.

Such a relatively short applicator can be used to act on the eyelashes or the eyebrows with the stem in a multitude of orientations relative to the row of eyelashes, because of the shape of the envelope surface which defines a ball or a ball-like shape.

By way of example, the multitude of orientations may comprise orientations that are spaced apart by 180° or even more, e.g. by more than 300° in one or more planes. The user can then easily select an orientation and/or a hand movement that is most appropriate for obtaining the desired makeup effect.

Where appropriate, the user may apply makeup by turning the applicator about its axis while moving it in contact with the eyelashes as though it were running along them.

The applicator can be used on its own, e.g. in order to finish off making up the eyelashes or eyebrows onto which a composition has already been applied, or after loading the application element with a composition, loading being performed either by placing the composition on the teeth or by bringing the teeth into contact with a cake of composition or by dipping the applicator into a receptacle containing the composition.

When the applicator is used in association with a receptacle having a wiper member, the shape of the applicator can lead to unequal wiping that can be used to advantage when applying makeup. For example, the zone of greatest diameter of the applicator will be more thoroughly wiped and will be better at separating and extending the eyelashes. The end zone of the applicator can be more heavily loaded with the composition and can be used, for example, to make patches, because it is possible to use the applicator in a multitude of orientations.

The applicator can make it possible to use up excess composition that is often to be found at the end of the brush as a result of the non-zero section of the wiper orifice, and that constitutes an impediment with conventional brushes.

All of the above-mentioned differences between the way teeth are implanted on the two sides A and B of the applicator member can be applied to the examples where the envelope surface is generally of a ball or ball-like shape. For example, the number of rows and/or the number of teeth per row can be greater on one side than on the other.

The applicator may comprise at least one tooth that is not perpendicular to the core. The portion of the core carrying the teeth may be of elongate shape along the longitudinal axis of the applicator.

The core may extend along a longitudinal axis that is rectilinear or curved. When the longitudinal axis of the core is curved, its orientation may vary by less than 90°.

In embodiments, the ratio R₁=dₘₐₓ/d_{core} is greater than or equal to 2.5, better greater than or equal to 3. d_{core} corresponds to the diameter of the circle in which the cross-section of the core is inscribed.

By way of example, d_{core} is greater than or equal to 2 mm and less than or equal to 3 mm, e.g. d_{core} less than or equal to 2.5 mm. For example dₘₐₓ may lie in the range 6 mm to 12 mm, e.g. lying in the range 8 mm to 9 mm.

The generally spherical shape of the applicator can be associated with teeth of varying length, rather than with variation in the diameter of the core supporting them, said variation being observed along the longitudinal axis of the applicator.

dₛₜₑₘ designates the diameter of the stem 7, and in the examples of the invention the ratio R₂=dₘₐₓ/dₛₜₑₘ is greater than or equal to 2.5, and better greater than or equal to 3.

The core 10 may be made in such a manner that its outer surface is situated in line with the outer surface of the stem 7, once the core is in place on the stem. This makes it possible to avoid having extra thickness present between the core and the stem.

By way of example, the diameter dₛₜₑₘ lies in the range 2.5 mm to 3 mm. The core may be held in a housing in the stem as a force-fit, by adhesive, and/or by die stamping the stem onto an endpiece that is made integrally with the core.

The longitudinal axis of the core need not be fully contained in line with the longitudinal axis of the stem.

Advantage should be taken of the fact that the teeth extend over a relatively short length along the longitudinal axis of the applicator to lengthen the stem and thus make the applicator easier to handle.

The relative lengthening in stem length can also serve to improve the extent to which the teeth are impregnated, since they can be moved over a greater distance inside the receptacle prior to being withdrawn therefrom. It is possible to obtain a greater proportion of teeth that are well loaded with the composition, in particular for receptacles that were not initially 100% full, as is common practice to avoid a problem of pistoning while the applicator is being withdrawn.

This can make it possible to use receptacles of relatively shallow depth, e.g. sample receptacles, without that shallow depth of the receptacle causing the applicator to be insufficiently loaded with composition. For example, it is possible to have R₃=dₘₐₓ/p_{receptacle} greater than or equal to 3.

The depth p_{receptacle} of the receptacle is defined as being the distance between the top of the receptacle with no applicator, i.e. the top end of the neck when it has such a neck, and the inside surface at the bottom of the receptacle, with the distance being measured along the longitudinal axis of the receptacle.

Preferably, R₄=dₘₐₓ/d_{f} (where d_{f} is the distance between the inside face of the bottom and the bottom end of the wiper member) that is likewise greater than or equal to 3.

The receptacle used may be of any kind, and in particular it may have two portions that are movable relative to each other, with one of the portions being turned relative to the other in order to increase the volume of one chamber defined inside the receptacle between the two portions and decrease the volume of another chamber, thereby causing the composition to pass between those two chambers. This passage takes place through a central portion of the receptacle in which the applicator member is housed. Such a receptacle is described for example in application EP 1 584 260.

The envelope surface may define a cross-section of outline that is circular, at least in part, e.g. having an outline that is circular over at least 180° around the core, or even completely circular, at least one point along the length of the core, and in particular in the vicinity of the maximum 130, or over at least a fraction of the length of the core, e.g. over the entire length of the fraction of the core that carries the bristles.

The cross-section may have an aspect ratio greater than 0.7, at least in the plane where the radius rₘₐₓ is at its maximum. The envelope surface need not have any notches or outwardly concave faces, e.g. in the plane where the radius rₘₐₓ is at its maximum.

The envelope surface may define at least one radius of length that varies in non-linear manner between the proximal end of the envelope surface and the maximum, e.g. varying along a circular arc or along any other curve other than a straight line. The term “radius” is used to designate the straight line segment going from the core perpendicularly to its axis and terminating in the envelope surface.

The envelope surface may define a radius that varies in non-radial manner between the maximum and the distal end of the envelope surface, e.g. varying along a circular arc.

Beside the maximum, e.g. towards the proximal or distal end of applicator, the envelope surface need not be conical.

The slope on one side of the maximum may vary, e.g. with increasing inclination relative to the longitudinal axis on going towards the distal or proximal end.

The envelope surface may increase and then decrease over at least 180° around the core, better 270° around the core, e.g. 360° around the core.

When seen from the side, i.e. perpendicularly to the axis of the core, the envelope surface may present a profile that is rounded on either side of the maximum.

In the example of FIG. 63, the envelope surface E is a surface of revolution presenting a cross-section that varies, e.g. having two portions 123 and 126 going towards the distal end of the core 10, which portions are substantially hemispherical and joined via an edge 130 defining a maximum where the radius r, i.e. the distance between the envelope surface E and the axis X of the core 10 is the greatest for the entire envelope surface E.

The cross-section of the brush may increase and then decrease on going from the proximal end towards the distal end of the envelope surface along at least two mutually perpendicular axes X1 and X2, as shown in FIG. 63.

In the longitudinal section plane containing the axis X1 that is perpendicular to the axis X, the radius r increases, reaches the maximum rₘₐₓ, and then decreases. The same applies in the longitudinal section plane containing the axis X2. The longitudinal section planes containing the respective axes X1 and X2 may be planes of symmetry for the envelope surface.

The distance j between the transverse plane containing the edge 130 and the maximum and the distal end of the envelope surface may be about 5 mm, for example.

The angle α formed between the slopes 140 and 141 of the envelope surface, and situated respectively on either side of the edge at the maximum 130 can be considerably greater than 120°, as can be seen in FIG. 67.

As shown in FIG. 67, each slope 140 or 141 is defined by the straight line passing through the maximum of the envelope surface E and fitting as closely as possible to the outline of the envelope surface in a longitudinal section plane over a distance of 1 mm along the axis X, on the corresponding side of the maximum.

In the example of a biconical envelope surface, the slopes are respectively the slopes of the two conical portions. In the example of an envelope surface that is spherical, being symmetrical about the plane containing the maximum 130, the angle α is closer to 180°.

In the example of FIG. 63, the aspect ratio of the brush in the transverse plane containing the edge at the maximum 130 is equal to 1, the envelope surface E presenting a circular outline centered on the axis X of the core 10.

The aspect ratio is defined by rₘᵢₙ/rₘₐₓ, where rₘₐₓ designates the maximum ratio in the cross-section under consideration, i.e. the greatest distance from the axis X of the core 10 to the envelope surface E, and where rₘₐₓ, designates the minimum radius, i.e. the shortest distance from the axis X of the core 10 to the envelope surface E in the section plane.

In the example of FIG. 68, the envelope surface is substantially biconical in shape.

The angle α between the slopes at the maximum is nevertheless relatively large, in particular greater than 120°, so as to approximate to the shape of a ball.

The radius r need not decrease down to zero at the ends of the envelope surface.

Whether in this example or in others, the diameter of the envelope surface E at the distal end may be greater than or equal to 4 mm, for example.

Where appropriate, the envelope surface E may be symmetrical on either side of a midplane containing the maximum 130.

In the example of FIG. 69, the envelope surface E presents a shape in longitudinal section that is generally lenticular. The cross-section defined by the envelope surface E increases for example from a proximal end where the radius r is substantially zero up to the maximum 130, and then decreases to an end where the radius r can again be substantially zero.

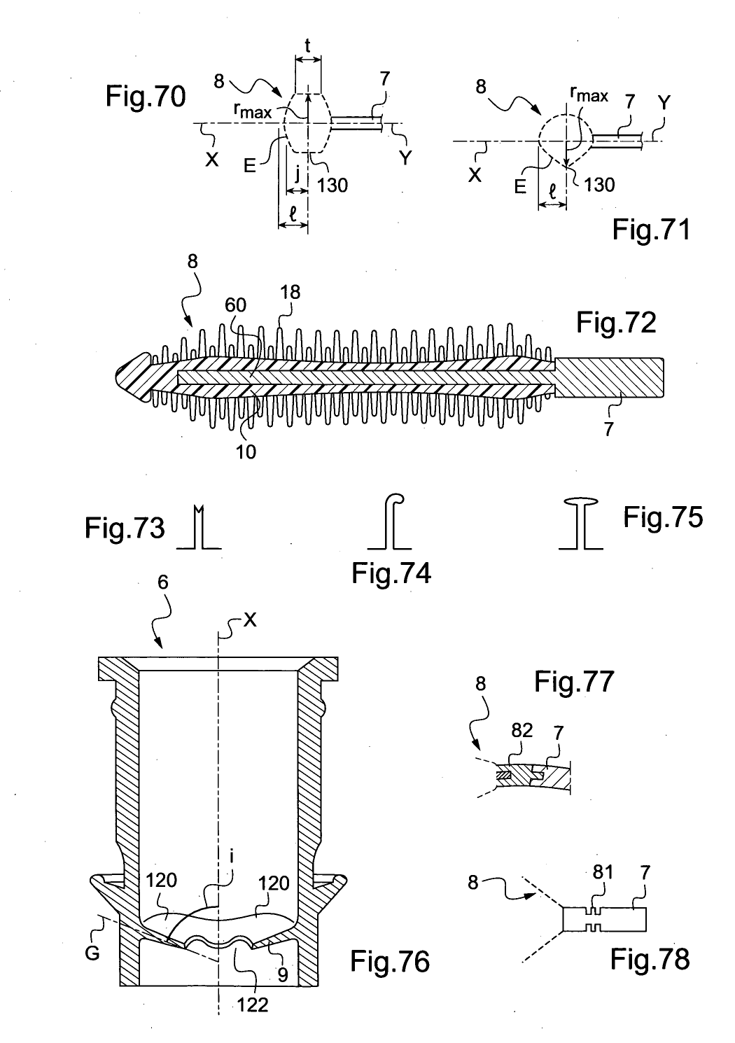

The maximum 130 may be defined by an edge, as shown in the above examples. In a variant, the maximum 130 may extend over a certain distance along the axis X, as shown in FIG. 70

In the example of this figure, the envelope surface

E defines a maximum cross-section of radius rₘₐₓ over a distance t prior to decreasing going towards the free end of the core. The middle of this portion of radius rₘₐₓ is situated, by way of example, at a distance l from the free end which is such that the ratio l/rₘₐₓ is less than 1.5. The length t may be greater than or equal to 1 mm, for example.

The envelope surface E, in particular in the plane where the cross-section is at its maximum, may present a shape that is not a surface of revolution.

For example, in a longitudinal section plane over its portion where the cross-section varies, the envelope surface may present an outline that is substantially semicircular on one side of the core and substantially triangular on the other side of the core, as shown in FIG. 71.

By way of example, the maximum radius rₘₐₓ may be defined by the substantially semicircular portion or by the substantially triangular portion.

In exemplary embodiments, the envelope surface may be spherical to within 20%, at least over its portion extending from a plane where the transverse dimension defined by the envelope surface E is at a maximum, all the way to the distal end.

As shown in FIGS. 65 to 66, the applicator may have teeth that point towards the proximal end of the applicator.

The applicator may comprise teeth that extend in more than four directions around the axis of the core, better that extend in at least eight directions around the axis X of the core, and in particular in more than eight directions.

As shown in FIGS. 66 to 68, the core 10 and the envelope surface E may both pass through a respective maximum cross-section at the same axial position along the axis X.

The teeth may present a height that varies such that their free ends define the profile desired for the envelope surface E. By way of example the core 10 may be elongate in shape, e.g. cylindrical, and the envelope surface may be generally ball-shaped.

By way of example, the radius r of the envelope surface E may vary by less than 50% between one-fourth and one-half of the distance between the plane containing the maximum 130 and the distal end of the applicator.

When the applicator is loaded with composition by being inserted into a receptacle through a wiper member, the teeth of the applicator may bend towards the distal end while the applicator is being withdrawn in certain embodiments. Some of the teeth may be long enough and close enough to the distal end for them, on bending, to cover the shorter teeth situated closer to the distal end. While bending on passing through the wiper member, the free ends of some of the teeth may come substantially level with the distal end of the core along the axis X.

In other aspects of the invention, the applicator may have an envelope surface with any one of the following characteristics.

The envelope surface (E) defined by the teeth may increase and then decrease going towards the distal end of the applicator.

The envelope surface may present a distal portion that is at least partially spherical or hemispherical to within 20%.

The total length qₘₐₓ along the longitudinal axis of the envelope surface (E) may be less than or equal to twice the greatest diameter dₘₐₓ of the cross-section of the envelope surface.

The total length qₘₐₓ may verify qₘₐₓ 1.75dₘₐₓ, preferably with qₘₐₓ≦1.5dₘₐₓ, better with qₘₐₓ≦1.25dₘₐₓ.

The angle α formed by the slopes of the envelope surface at least in a longitudinal section on either side of a maximum of the envelope surface may be greater than 120°.

The envelope surface may have an aspect ratio (rₘᵢₙ/rₘₐₓ) greater than 0.7, at least in the transverse plane including the maximum 130.

The greatest radius rₘₐₓ measured at the maximum 130 may be greater than or equal to 3 mm.

The distance (l) from the transverse plane containing the maximum 130 to the distal end of the applicator may be less than or equal to 12 mm.

The maximum 130 may be situated at a distance (rₘₐₓ) lying in the range 2.5 mm to 2.75 mm from the axis (X) of the core 10.

The ratio R₁=dₘₐₓ/d_{core} may be greater than or equal to 2.5, where d_{core} corresponds to the diameter of the circle in which the cross-section of the core is inscribed.

The ratio R₂=dₘₐₓ/dₛₜₑₘ may be greater than or equal to 2.5, where dₛₜₑₘ corresponds to the maximum diameter of the stem.

Such an applicator may also present at least one of the characteristics of the applicators described with reference to the figures of the present application.

In the variant embodiment shown in FIG. 72, the core comprises a recess in which there is engaged a support portion 60, e.g. made of metal or plastics material. The core can be configured to be fastened to the support 60, or it can be free to turn or to move in translation relative to the support 60.

The choice of orientation of the applicator member can result in different makeup effects.

Naturally, the invention is not limited to the above-described embodiments, the characteristics of which can be combined together within variants not shown.

The teeth of at least one row could present different heights, passing through an extremum between the extreme teeth of the row, for example.

At least one of the teeth 18 of the rows 17 could present a surface state that is not smooth, e.g. having ridges as a result of molding or roughness linked to the presence of a filler in the plastics material, for example.

The applicator member could be made with a plastics material that comprises magnetic particles. The magnetic field created by such particles, that could be magnetizable and/or magnetized, could, for example, exert an effect on the eyelashes and/or interact with magnetic fibers or pigments that are present in the composition.

The applicator member could be made with flocking, said flocking extending over the teeth only, for example.

At their free ends, the teeth could present respective portions in relief or a particular shape, e.g. a fork, a hook, or a bead, as shown in FIGS. 73 to 75. By way of example, the hook could extend transversally, parallel, or obliquely relative to the longitudinal axis X of the core. In order to obtain the bead, it is possible to heat the applicator member in such a manner as to melt the end of the teeth, for example. In order to obtain the forks or the hooks, it is possible to abrade the applicator member, for example.

The rows 17 could comprise different numbers of teeth, with one of the rows being shorter than another, for example.

All of the teeth could be connected to the core along a direction that is contained in a plane that is perpendicular to the axis X. This could be otherwise, and teeth could slope towards the distal or proximal end.

The wiper member could be made in some other way, e.g. it could comprise a block of foam that could be slotted. The wiper member could be as described in patent applications or U.S. Pat. Nos. 2005/0028834, 2005/0175394, 2004/0258453, 6,375,374, 6,328,495, for example.

The wiper lip 9 could advantageously be undulating, having a radially-inner free edge defining an orifice 122 through which the applicator member can pass, as shown in FIG. 76. The wiper lip 9 could comprise undulations 120 that extend around the orifice 122. The wiper member 9 can comprise a number of undulations 120 lying in the range 3 to 12, for example.

The wiper lip 9 could extend generally along a cone that converges towards the bottom of the receptacle, and that has a generator line G forming an angle i with the axis X of the receptacle. In a variant, the wiper lip 9 could extend generally along a mid-plane that is perpendicular to the axis X, or it could even extend generally along a cone that converges towards the outlet of the receptacle.

The wiper member could also be adjustable, where appropriate.

The stem 7 to which the core is fastened could be flexible at least in part, and in particular could be entirely flexible, in particular in the proximity of the applicator member. By way of example, the stem could comprise at least one flexible element 80, as shown in FIG. 77, or at least one elastomer element, for example, or it could present a shape that imparts flexibility, e.g. at least one notch 81 as shown in FIG. 78. By way of example, the flexible or elastomer element could be flocked and/or could also be used for applying the composition.

In order to use the device 1, the user can unscrew the closure cap 5 and remove the applicator member 8 from the receptacle 3.

After the applicator member 8 has passed through the wiper member 6, a certain quantity of composition remains between the rows 17 and between the teeth 18 of the rows, and can be applied to the eyelashes or the eyebrows by the user.

The relatively large number of teeth and their disposition on the applicator member make it possible to apply makeup neatly.

The wiping movement used to apply makeup to the eyelashes or the eyebrows can possibly be accompanied by the applicator member being turned about the axis X. The obliquely-oriented teeth can be directed towards the eyelashes when applying makeup.

Still in a variant, vibration could be applied to the applicator member during application, combing, or while taking the composition, e.g. as described in application WO 2006/090343.

Naturally, the invention is not limited to the above-described embodiments, the characteristics of which can be combined together within variants not shown.

The term “comprising a” should be understood as being synonymous with the term “comprising at least one” unless specified to the contrary.

The expression “lying in the range” should be construed as including the limits of the range.

1. An applicator for combing eyelashes and/or eyebrows and/or for applying a cosmetic, makeup, or a care product thereto, the applicator comprising a molded applicator member comprising a core that is elongate along a longitudinal axis, and rows of teeth of which at least one first row of teeth is molded out of a first material, and at least one second row of teeth is molded out of a second material that is different from the first material, wherein the two materials have the same chemical nature and differ in hardness.

2. An applicator according to claim 1, wherein the first and the second rows differ in a spacing of the teeth in the row or a spacing between the rows.

3. An applicator according to claim 1, wherein the first and the second rows differ in a shape of the teeth or in a length of the teeth.

4. An applicator according to claim 1, wherein at least two rows differ in at least one of the following ways: an implantation of the teeth in the row; a number of teeth in the row; a thickness of the teeth measured perpendicularly to their longitudinal direction; a shape of a cross-section of the teeth; a length of the teeth; a shape of the teeth; and a spacing of the teeth in the row.

5. An applicator according to any preceding claim 1, comprising an envelope surface that is not cylindrical.

6. An applicator according to claim 5, wherein the envelope surface is in a shape selected from the following list: shape of a peanut, an American football, frustoconical, or two half-shapes selected from amongst the above-mentioned shapes and fitted together along a diametral plane containing the longitudinal axis of the core.

7. An applicator according to claim 1, comprising a zone that does not have teeth.

8. An applicator according to claim 1, wherein the core comprises first and second portions that extend along the longitudinal axis, and from which the first and second rows extend respectively, the first portion being made out of the first material, and the second portion being made out of the second material.

9. An applicator according to claim 8, wherein each of the first and second portions of the core constitute substantially half of the core.

10. An applicator according to claim 7, wherein each of the first and second portions of the core constitute substantially one third, one fourth, one fifth, one sixth, or one eighth of the core.

11. An applicator according to claim 1, wherein, over at least a fraction of their length, the core and/or portions of the core have a cross-section of shape selected from the following list: circular; semi-circular; elliptical; semi-elliptical; polygonal; triangular; square; rectangular; pentagonal; hexagonal; and octagonal.

12. An applicator according to claim 1, wherein a row of teeth comprises a succession of teeth that extend alternately on opposite sides of a separation surface.

13. An applicator according to claim 1, wherein each of two consecutive teeth of a row extends along a relative direction from the core, the two directions forming a non-zero angle between them.

14. An applicator according to claim 1, wherein at least one tooth, or even all of the teeth, present at least one plane face that is parallel to their long direction.

15. An applicator according to claim 1, wherein at least two second rows of teeth are molded out of the second material.

16. An applicator according to claim 1, wherein the two materials alternate around the longitudinal axis of the core at its periphery.

17. An applicator according to claim 1, wherein the first and second rows are substantially identical.

18. An applicator according to claim 17, wherein the first and second rows are images of each other on turning about the longitudinal axis.

19. An applicator according to claim 1, wherein the teeth of the first row and the teeth of a second row are substantially identical.

20. An applicator according to claim 1, comprising a plurality of first rows of teeth molded out of the first material, the first rows of teeth being images of one another on turning about the longitudinal axis of the core.

21. An applicator according to claim 1, wherein the second rows of teeth are images of one another on turning about the longitudinal axis of the core.

22. An applicator according to claim 1, wherein at least two successive teeth of a row are non-touching at their bases.

23. An applicator according to claim 1, wherein, when the applicator is observed perpendicularly to its longitudinal axis, at least two consecutive teeth of a row define a V-shaped groove.

24. An applicator according to claim 1, wherein, teeth of one row and teeth of another row extend in different directions.

25. An applicator according to claim 1, wherein the teeth of a row have bases that are substantially in alignment.

26. An applicator according to claim 1, wherein at least one tooth presents a cross-section that is circular, semi-circular, semi-elliptical, elliptical, polygonal, triangular, square, rectangular, octagonal, parallelogram-shaped, lozenge-shaped, or oval.

27. An applicator according to claim 1, wherein the longitudinal axis of the core is rectilinear.

28. An applicator according to claim 1, wherein the longitudinal axis of the core is curved.

29. An applicator according to claim 1, wherein the core comprises a recess in which there is engaged a support portion.

30. An applicator according to claim 1, wherein the portion of the core that supports the teeth is solid.

31. An applicator according to claim 1, wherein the core has a cross-section that passes via a minimum along the longitudinal axis of the core.

32. An applicator according to claim 1, wherein the core comprises at least one face from which teeth extend, the face presenting a width that varies along the longitudinal axis of the core.

33. An applicator according to claim 1, including a stem, the applicator member extending from a first end of the stem.

34. A packaging and applicator device for applying a cosmetic or a care product to eyelashes and/or eyebrows, the device comprising an applicator as defined in claim 1, and a receptacle containing a composition for application to the eyelashes and/or the eyebrows.

35. A method of manufacturing a molded applicator member for combing eyelashes and/or eyebrows, and/or for applying a composition to the eyelashes and/or the eyebrows, the applicator member comprising a core and teeth, the method comprising the following steps:
injecting a first material for molding a first portion of the applicator member including teeth; and
injecting a second material for molding a second portion of the applicator member including teeth.

36. A method according to claim 35, wherein the final configuration of the applicator member is obtained at the time of injection.

37. A method according to claim 35, wherein the final configuration of the applicator member is obtained successively over time during injection.

38. A method according to claim 35, wherein during injection, the second material passes through openings in the first portion.
